(19) United States
(12) Patent Application Publication
(10) Pub. No.: US 2005/0278248 A1
(43) Pub. Date: Dec. 15, 2005

(54) Simulation program and simulation apparatus

(75) Inventors: Shigetoshi Sakimura, Hitachi (JP); Takeshi Yokota, Hitachi (JP); Kaoru Kawabata, Hitachi (JP); Shunsuke Minami, Mito (JP); Yoshifumi Ajioka, Shonan (JP); Kouji Endou, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/059,450

(22) Filed: Feb. 17, 2005

(30) Foreign Application Priority Data
Jun. 10, 2004 (JP) 2004-172395

(51) Int. Cl. G06F 17/60

(52) U.S. Cl. 705/38

(57) ABSTRACT

Simulation for evaluating approval/rejection of an action plan of the type in which work breakdown struction is changed by influences of external risk factors is achieved. A simulation apparatus includes a plan/risk input portion for accepting input of action plan data and risk scenario data, a plan/risk simulation portion for conducting simulation of an action plan by using the action plan data and the risk scenario data so accepted, and a plan evaluation output portion for evaluating a simulation result. The plan/risk simulation portion simulates occurrence of a risk phenomenon by using the risk scenario data, determines influence information given by the risk phenomenon to the action plan when the risk phenomenon is simulated as occurring and conducts simulation of the action plan by reflecting the influences of the risk scenario on the action plan by using the influence information so determined.

### BACKGROUND OF THE INVENTION

This invention relates to a technology for simulating a project. More particularly, the invention relates to a technology for simulating a project of the type in which a work structure is changed in accordance with influences of external risk factors such as in risk management and research and development.

Activities of a project type that go beyond conventional boundaries such as departments and sections, special posts, and so forth, have increased in enterprises and administrative organs in place of activities of a fixed organization type. It is of utmost importance to appropriately conduct prior risk evaluation in the activities of such a project type.

JP-A-2001-195483 describes a project risk evaluation technology as one of risk management methods of project type activities. This project risk evaluation technology contemplates to grasp in advance risk factors of a management object project on the basis of similarity between projects that have been executed in the past and the management object project that is now to be executed and on risk factors of the projects executed in the past.

This patent document conducts risk evaluation by utilizing the similarity between the projects that have been executed in the past and the project that is now to be executed. Therefore, the risk evaluation technology of this patent document is effective for those types of projects (architectural projects, for example) WBS (Work Breakdown Structure) of which is not fundamentally changed by the influences of the risk factors inside the project.

However, this risk evaluation technology is not free from the problem that it cannot be applied easily to the projects for which similarity to the past projects is not insured. The projects for which similarity is not insured include projects of the type in which the execution content is changed in accordance with the content of external risk factors such as risk management, research and development.

### SUMMARY OF THE INVENTION

It is therefore an object of the invention to achieve simulation for evaluating approval/rejection of a project (action plan) of the type WBS of which is changed by influences of external risk factors.

To solve the problem described above, an embodiment of the invention is applied to a simulation program that causes a computer to execute a processing for simulating an action plan. The computer includes a storage device, an input device and an output device.

The simulation program causes the computer to execute the steps of accepting input of action plan data for simulating the execution of the action plan through the input device and storing the action plan data so accepted into the storage device; accepting input of risk scenario data containing at least occurrence condition information of a risk phenomenon and influence information of the risk phenomenon on the action plan through the input device and storing the risk scenario data so accepted into the storage device; reading out the action plan data and the risk scenario data from the storage device and executing a simulation processing for the execution of the action plan by using the action plan data and the risk scenario data so read out; and calculating plan evaluation result information by applying a predetermined statistic processing to the simulation result and outputting the plan evaluation result information to the output device. The simulation step comprises the steps of simulating the occurrence of the risk phenomenon by using the occurrence condition information of the risk phenomenon contained in the risk scenario data, determining influence information of the risk phenomenon on the action plan by using the influence information contained in the risk scenario data when the risk phenomenon is simulated as occurring, and simulating the execution of the action plan by reflecting the influences of the risk scenario on the action plan by using the action plan data and the influence information of the risk phenomenon on the action plan so obtained.

When conducting simulation by using the action plan data and the risk scenario date, the invention simulates the occurrence of the risk phenomenon by using the risk scenario data, determines the influence information of the risk phenomenon on the action plan when the risk phenomenon is simulated as occurring, and reflects the influences of the risk scenario on the action plan by using the influence information of the risk phenomenon so determined on the action plan.

Therefore, the invention can execute simulation while reflecting the influences of the external risk factors even in the projects of the type whose WBE is changed by the influences of the external risk factor.

Other objects, features and advantages of the invention will become apparent from the following description of the embodiments of the invention taken in conjunction with the accompanying drawings.

### BRIEF DESCRIPTION OF THE DRAWINGS

FIG. 1 is a functional block diagram of a simulation apparatus according to a first embodiment of the invention;

FIG. 2 is an explanatory view useful for explaining a hardware construction of the simulation apparatus according to the first embodiment of the invention;

FIG. 3 schematically shows a data structure of action program data 140 in the first embodiment of the invention;

FIG. 4 schematically shows a data structure of risk scenario data 150 in the first embodiment of the invention;

FIG. 5 schematically shows a data structure of action/risk simulation result data 160 in the first embodiment of the invention;

FIGS. 6A and 6B typically show an action plan input view and a risk scenario input view in the first embodiment of the invention;

FIG. 7 is an explanatory view useful for explaining a processing flow of an action/simulation processing in the first embodiment of the invention;

FIG. 8 is an explanatory view useful for explaining a processing flow of a simulation processing in the action plan in the first embodiment of the invention;

FIG. 9 is an explanatory view useful for explaining a processing flow of a simulation processing for the risk scenario in the first embodiment of the invention;

FIG. 10 typically shows a start condition tree of the action/risk simulation processing in the first embodiment of the invention;

FIG. 11 is an explanatory view useful for explaining a processing flow of a plan evaluation output processing in the first embodiment of the invention;

FIG. 12 typically shows a data structure of the plan evaluation result data 170 in the first embodiment of the invention;

FIGS. 13A and 13B typically show a plan evaluation screen displayed by a plan evaluation output processing portion 130 in the first embodiment of the invention;

FIG. 14 typically shows a data structure of action plan data 140 in the second embodiment of the invention;

FIG. 15 typically shows a data structure of risk scenario data 150 in the second embodiment of the invention;

FIGS. 16A and 16B typically show an action plan input view and a risk scenario input view in the second embodiment of the invention;

FIG. 17 is an explanatory view useful for explaining a processing flow of a simulation processing of the action plan in the second embodiment of the invention;

FIG. 18 is an explanatory view useful for explaining a processing flow of a simulation processing of a risk scenario in the second embodiment of the invention; and

FIG. 19 typically shows a start condition tree of a plan/risk simulation processing in the second embodiment of the invention.

### DESCRIPTION OF THE EMBODIMENTS

A simulation apparatus according to preferred embodiments of the invention will be hereinafter explained.

### First Embodiment

The first embodiment of the invention will be initially explained.

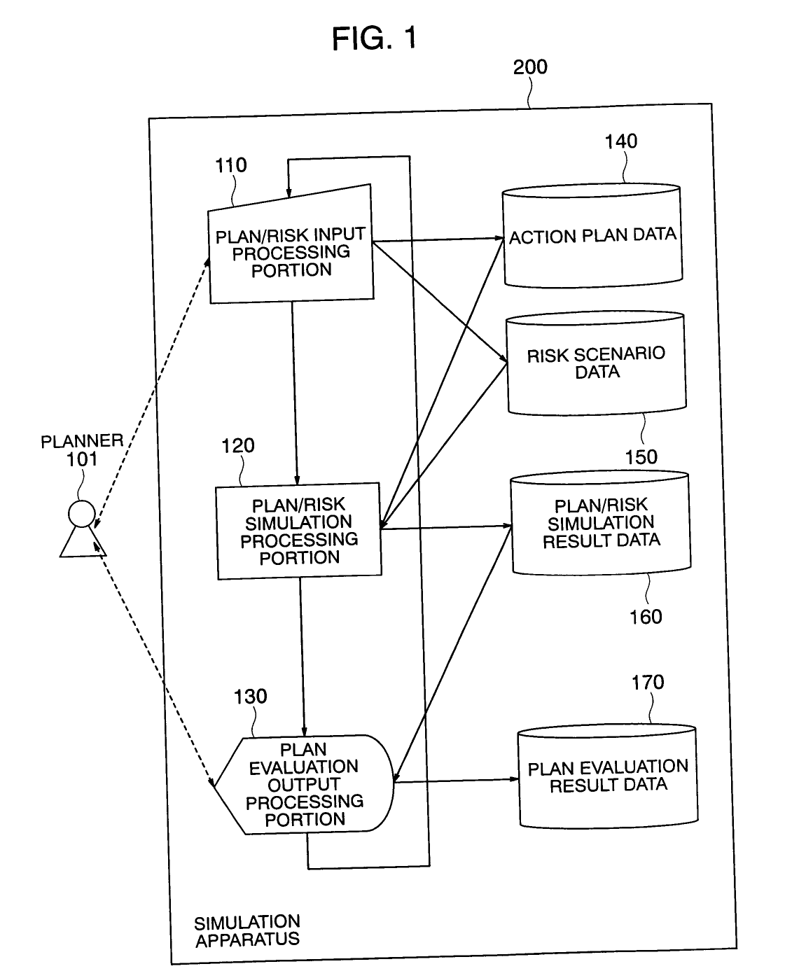

Function and construction of a simulation apparatus according to this embodiment will be initially explained with reference to FIG. 1.

FIG. 1 is a functional block diagram of the simulation apparatus according to the first embodiment of the invention.

The simulation apparatus 200 includes a plan/risk input processing portion 110, a plan/risk simulation processing portion 120 and a plan evaluation output processing portion 130 as shown in the drawing.

The simulation apparatus 200 holds action plan data 140, risk scenario data 150, plan/risk simulation result data 160 and plan evaluation result data 170. The action plan data 140 represents data for executing simulation for conducting a project of a simulation object (hereinafter called “action plan”, too). The risk scenario data 150 represents data for executing simulation for the occurrence of risks that may affect the action plan. The plan/risk simulation result data 160 represents data representing the result of the simulation processing by using the action plan data 140 and the risk scenario data 150. The plan evaluation result data 170 represents data generated by applying a predetermined statistic processing to the simulation result. Incidentally, the action plan data 140, the risk scenario data 150, the risk simulation result data 160 and the plan result evaluation data 170 will be explained elsewhere in further detail.

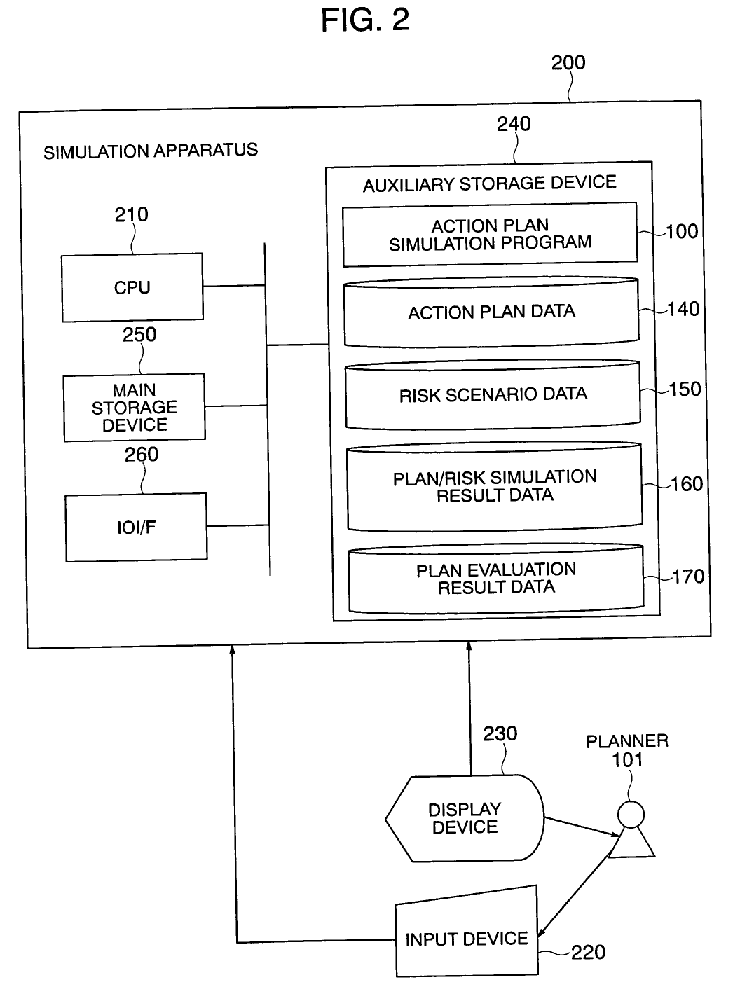

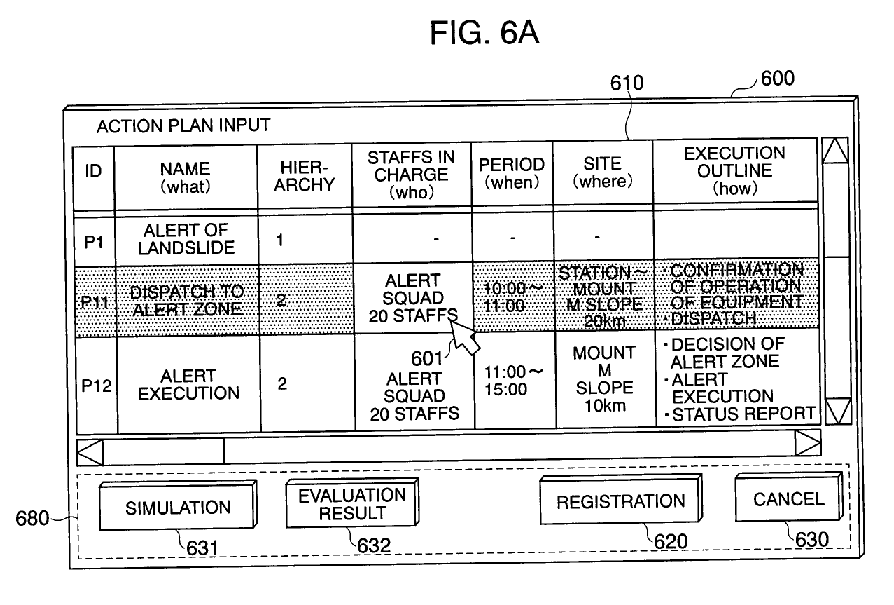

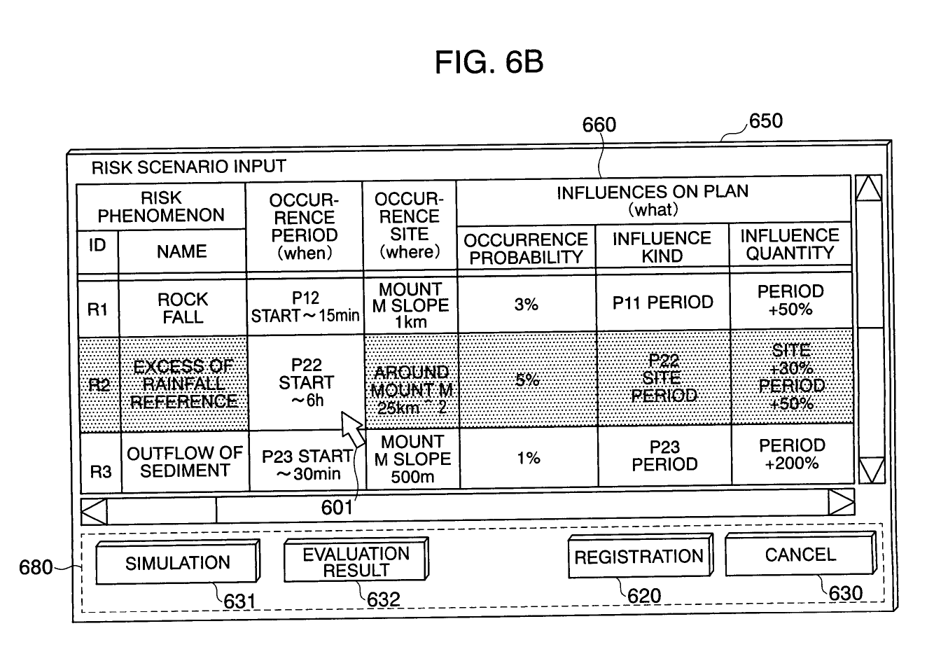

The plan/risk input processing portion 110 accepts the input of the action plan data 140 and the risk scenario data 150. More concretely, the plan/risk input processing portion 110 causes a display device 230 (see FIG. 2) to display an input view (see FIG. 6) for accepting the input of the action plan data and accepts the action plan data that a planner 101 inputs through an input device 220 (see FIG. 2). The plan/risk input processing portion 110 also causes the display device 230 to display an input view (see FIG. 6) for accepting the input of the risk scenario data and accepts the risk scenario data that the planner 101 inputs through the input device 2.

The plan/risk simulation processing portion 120 conducts simulation by using the action plan data 140 and the risk scenario data 150 the plan/risk input processing portion 110 accepts. The plan/risk simulation processing portion 120 generates the plan/risk simulation result data 160 representing the simulation result. Incidentally, the plan/risk simulation processing portion 120 in this embodiment conducts simulation of the risk scenario by reflecting the influences of the occurrence of risks on the action plan and the influences of the execution of the action plan on the risk scenario with one another as will be later described.

The plan evaluation output processing portion 130 generates the plan evaluation result data 170 by applying the statistic processing to the plan/risk simulation result data 160.

The hardware construction of the simulation apparatus according to this embodiment will be successively explained with reference to FIG. 2.

FIG. 2 is an explanatory view useful for explaining the hardware construction of the simulation apparatus according to this embodiment.

The simulation apparatus 200 includes a CPU (Central Processing Unit) 210 for executing various kinds of programs, a main storage device 250 for temporarily storing programs and various kinds of data executed by CPU 210, an auxiliary storage device 240 such as a hard disk for storing in advance the programs executed by CPU 210 and an IOI/F 260 for controlling transmission and reception of data to and from external apparatuses. The simulation apparatus 200 can use a computer, for example.

An input device 220 for accepting the input of various kinds of data from the planner 101 and a display device 230 for displaying the image data outputted by the simulation apparatus 200 may well be connected to the simulation apparatus 200. Concrete constructions of the input device 220 and the display device 230 are not limited, in particular. The input device 220 can use a keyboard or a mouse, for example. The display device 230 can use a liquid crystal display or a CRT, for example.

The auxiliary storage device 240 stores a control program (not shown in the drawing) for controlling the simulation apparatus 200, the action plan simulation program 100, the action plan data 140, the risk scenario data 150, the plan/risk simulation result data 160 and the plan evaluation result data 170. The action plan simulation program 100 is the program that causes the simulation apparatus 200 to execute the function of each portion described above (plan/risk input processing portion 110, plan/risk simulation processing portion 120 and plan evaluation output processing portion 130).

The function of each portion described above (plan/risk input processing portion 110, plan/risk simulation processing portion 120 and plan evaluation output processing portion 130) is achieved when CPU 210 loads the action plan simulation program 100 stored in the auxiliary storage device 240 into the main storage device 250.

More concretely, when CPU 210 executes the action plan simulation program 100, CPU 210 accepts the action plan data 140 and the risk scenario data 150 through the input device 220. CPU 210 stores the data so accepted into the auxiliary storage device 240 by the action plan simulation program 100. When CPU 210 executes the action plan simulation program 100, the action plan data 140 and the risk scenario data 150 stored in the auxiliary storage device 240 are read out to the main storage device 250 and the simulation processing is executed by using the action plan data 140 and the risk scenario data 150 so read out. CPU 210 stores the plan/risk simulation result data 160 into the auxiliary storage device 240 as the simulation result by using the action plan simulation program 100. Furthermore, when CPU 210 executes the action plan simulation program 100, the plan/risk simulation result data 160 stored in the auxiliary storage device 240 is read out to the main storage device 250 and a processing for calculating the data for evaluating the simulation result is executed. CPU 210 stores the plan evaluation result data 170 as the evaluation result into the auxiliary storage device 240 by the action plan simulation program 100. The display device 230 displays the plan evaluation result data 170 so calculated when CPU 210 executes the action plan simulation program 100.

Incidentally, the hardware construction described above is merely illustrative. For example, the auxiliary storage device 200 may be connected to outside of the simulation apparatus 200 through the IOI/F 260. Each data of the action plan data 140 may be stored in a separate storage device. A printer, etc. may be connected to the simulation apparatus 200 so that the plan evaluation output processing portion 130 can cause the printer to print the plan evaluation result data 170.

In the explanation of the embodiment given above, the action plan data 140, the risk scenario data 150, the plan/risk simulation result data 160 and the plan evaluation data 170 are all stored in the auxiliary storage device 240 by way of example, but this arrangement is not restrictive, in particular. For example, CPU 210 may well store the action plan data 140, the risk scenario data 150, the plan/risk simulation result data 160 and the plan evaluation data 170 in only a predetermined area of the main storage device 250 without storing them in the auxiliary storage device 240.

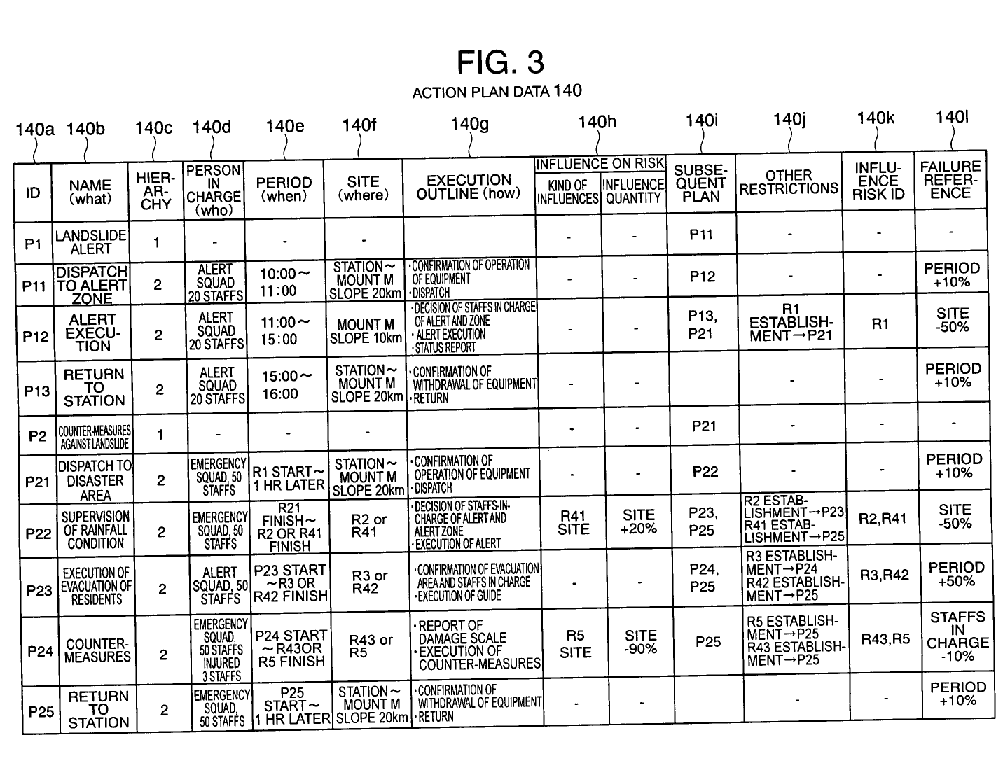

Subsequently, the data structure of the action plan data 140 in the first embodiment will be explained with reference to FIG. 3.

FIG. 3 schematically shows the data structure of the action plan data 140 in the first embodiment. The action plan data 140 has a hierachical structure of partial plan groups. Each partial plan includes ID, name, hierachical information, persons-in-charge of execution, execution period, execution site, execution outline, influences on risks, subsequent plans, other restrictive conditions, influence risk ID and failure standard.

The action plan data 140 has a plurality of entries 140a to 1401 for storing data as shown in FIG. 3. Data associated with the data stored in the entry 140a are stored in entries 140b to 1401.

The entry 140a stores “ID” as an identifier primarily allocated to each partial plan contained in the action plan. The entry 142b stores “name” of the partial plan specified by “ID” stored in the entry 140a. The “name” defines “what” the partial plan is to do.

The entry 140c stores data representing the level of “hierarchy” to which the partial plan specified by the “ID” stored in the entry 140a belongs. In this embodiment, the data representing the level of “hierarchy” is not particularly limited and the following explanation will deal with the case where the level of “hierarchy” is represented by “numerical value”. Incidentally, the smaller the “numerical value”, the higher becomes the level of “hierarchy” in the drawing. In other words, the level of “hierarchy” shown in the drawing represents that the partial plans P1 and P2 belong to the highest hierarchy. The diagram represents also that P11, P12 and P13 belong to P1 and P21, P22, P23, P24 and P25 belong to P2.

The entry 140d stores data representing persons or sections in charge that execute the partial plan specified by “ID” stored in the entry 140a. Data representing “who” in the entry 140d defines “who (or which section)” is in charge for execution with “how many persons (or sections)”.

The entry 140e stores data representing the “execution period (when)” of the partial plan specified by the “ID” that is stored in the entry 140a. This data representing the execution period defines the execution period of the partial plan from “which date” to “which date”. Incidentally, the execution period need not always be designated by the absolute date. For example, the execution period may use the correlative time with other partial plans or with a later-appearing risk phenomenon or with the time of establishment of other restrictive conditions that will be later described.

The entry 140f stores data representing “execution site (where)” of the partial plan specified by the “ID” that is stored in the entry 140a. The data representing this execution site defines the execution site of the partial plan as to “where” and in “which area (or distance or height)” the partial plan should be executed.

The entry 140g stores data representing “execution outline (how)” of the partial plan specified by the “ID” that is stored in the entry 140a. The “execution outline (how)” represents the detail of an execution method of each partial plan. This execution outline (how) defines “how” the partial plan is to be executed.

The entry 140h stores data representing “influences on risk” given by the partial plan specified by the “ID” that is stored in the entry 140a. The data representing the “influences on risk” defines “risk phenomenon”, “kind of risk” and “influence quantity” that may exert the influences.

The entry 140i stores “ID” of the partial plan to be executed next to the partial plan specified by the “ID” that is stored in the entry 140a. The entry 140j stores data representing shift conditions from the partial plan specified by the “ID” that is stored in the entry 140a to the partial plan specified by the “ID” that is stored in the entry 140i (hereinafter called “other restrictive conditions”). For example, “other restrictive conditions” include a condition of the shift to the next partial plan on the premise of the occurrence of a certain risk phenomenon.

The entry 140k stores data (“risk ID”) specifying the risk phenomenon having an influence relation with the partial plan specified by the ID that is stored in the entry 140a. For example, when a risk phenomenon that occurs on the condition of the start of the partial plan specified by the ID stored in the entry 140a exists, the entry 140k stores the “risk ID” of that risk phenomenon.

The entry 1401 stores “failure standard (or success standard)” for judging whether or not the partial plan specified by the ID stored in the entry 140a proves failure (or successful).

As described above, this embodiment employs the data structure in which the action plan is classified and illustrated into a plurality of partial plans. Therefore, the embodiment can explicitly define each partial plan as to “who” executes this partial plan “when”, “where” and “how”. These kinds of information will be abbreviated from time to time as “4W1H” in the following description.

Explanation will be given hereby on the partial plan having “P11” allocated to “ID” among the partial plans contained in the action plan data 140 shown in FIG. 3. In the partial plan having “P11” for “ID”, “name (what)” is “dispatch to alert zone”, “hierarchy” is “2”, “persons in charge (who)” are “20 of alert squad”, “period (when)” is “10:00 to 11:00”, “site (where)” is “station at slope of M mountain 20 km”, and “execution outline (how)” is “confirmation of operation of equipment and dispatch”.

The partial plan of “P11” is defined in such a manner as not to affect the risk scenario (entry 140h). The “subsequent plan”, that is, the partial plan to be executed next to “P11”, is “P12” (entry 140i) and “other restrictions” and “influence risk ID” do not exist (entries 140j, k). The corresponding entry 1401 of the partial plan of “P11” stores “period (10:00 to 11:00)+10%” as the data representing the “failure standard”. In other words, in the partial plan of “P11”, the data for judging that the partial plan of P11 proves failure when the execution period exceeds “10%” of the “execution period (10:00 to 11:00)” is defined.

This embodiment uses the arrangement structure as the main expression method of the data structure but other expression methods may be used, too. For example, means for expressing the subsequent plans may use a pointer to the corresponding partial plan.

Next, the data structure of the risk scenario data 150 will be explained.

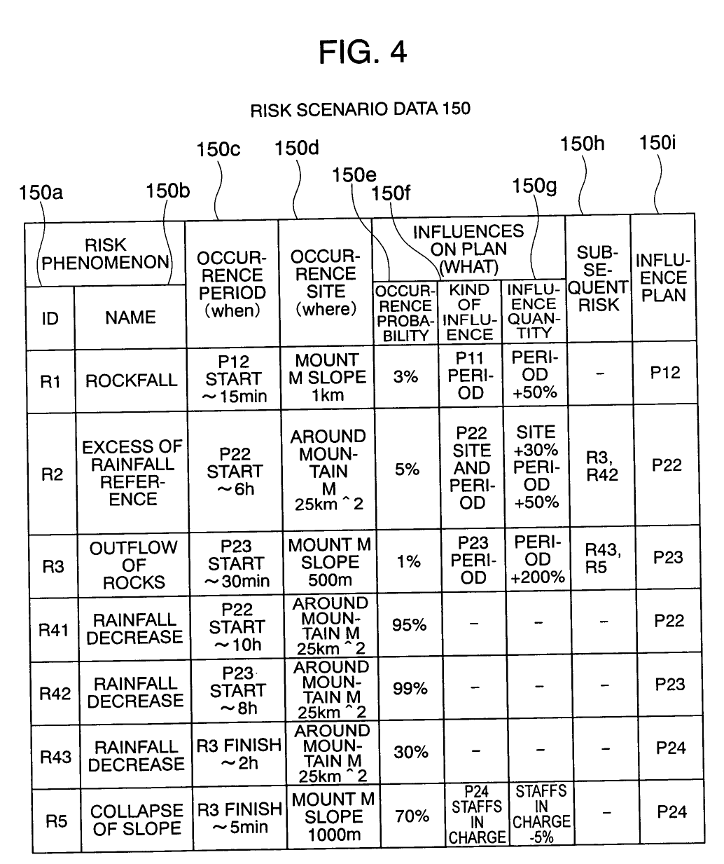

FIG. 4 schematically shows the data structure of the risk scenario data 150. The risk scenario data 150 defines the scenario of the risk phenomena (fall of rocks, for example) that may affect the action plan and includes a plurality of risk phenomena. Each risk phenomenon has risk ID, name, occurrence period, occurrence site, influences on plans (occurrence probability, kind of influence, influence quantity), subsequent risk and influence plan ID. Incidentally, the risk scenario data has a tree (or net) structure of risk phenomenon group.

The risk scenario data 150 has a plurality of entries 150a to 150i for storing risk ID, name, occurrence period, occurrence site, influences on plans, subsequent risks and influence plan ID of each risk phenomenon.

The entry 150a stores “risk ID” as an identifier that is primarily allocated to the risk phenomenon. The entry 150b stores “name” of the risk phenomenon specified by the “risk ID” stored in the entry 150a.

The entry 150c stores data (occurrence period) representing an expected period of the occurrence of the risk phenomenon specified by the “risk ID” stored in the entry 150a. This occurrence period defines the occurrence period of each risk phenomenon “from when to when”. Incidentally, the occurrence period need not always be designated by the absolute date. For example, the occurrence period may use the relative time with other risk phenomena and partial plans.

The entry 150d stores data representing the occurrence site of the risk phenomenon specified by the “risk ID” stored in the entry 150a. The occurrence site defines “where” and in “which area (or distance or height)” each risk phenomenon occurs.

The entries 150e to 150g store data (occurrence probability, kind of influences, influence quantity) representing the influences on the action plan exerted by the risk phenomenon specified by the “risk ID” that is stored in the entry 150a imparts.

The “occurrence probability” stored in the entry 150e defines the expected probability of the occurrence of the risk phenomenon. The “influence kind” stored in the entry 150f designates which partial plan is affected and which element among the 4W1H information contained in the affected partial plan is affected when the risk phenomenon occurs. The “influence quantity” stored in the entry 150g defines which quantity of influence is exerted on the partial plan designated by the “influence kind” described above and on the element of the affected partial plan. In this way, the data representing the influences on the action plan define “what” occurs due to the occurrence of the risk phenomenon.

The entry 150h stores the “risk ID” of the risk phenomenon that may occur next to the risk phenomenon specified by the “risk ID” that is stored in the entry 150a. The entry 150i stores the ID of the partial plan having the influence relation with the risk phenomenon specified by the “risk ID” that is stored in the entry 150a.

As described above, this embodiment can explicitly define “when” and “where” each partial plan occurs and “what” occurs as the result of the risk phenomenon. Incidentally, these kinds of information will be abbreviated from time to time as “3W” in the following description. Though this embodiment represents the example where the risk factors do not have the hierachical structure, the embodiment may well use the tree structure having hierarchy by adding the hierachical information similar to that of the action plan data 140.

Explanation will be given hereby on the risk phenomenon having “R1” allocated to “risk ID” among the risk phenomena contained in the risk scenario data 150 shown in FIG. 4. In the risk phenomenon having “R1” for the “risk ID”, “name (what)” is “fall of rocks”, “period (when)” is “for 15 minutes from the start of the partial plan of P12” and “site (where)” is “slope of M mountain 1 km”(entries 150a to 150d). The risk phenomenon of “R1” defines from the data of the corresponding entry 150e that the “occurrence probability” is “3%”. The influence due to the risk phenomenon of “R1” is defined as exerting the influence of “period+50%” on the period of the partial plan of “P11” from the corresponding entries 105f and 150g. In other words, it is defined that when the “fall of rocks” as the risk phenomenon of “R1” occurs, the “period” of the “dispatch to the alert zone” of “P11” increases 50%.

Next, the data structure of the plan/risk simulation result data 160 will be explained.

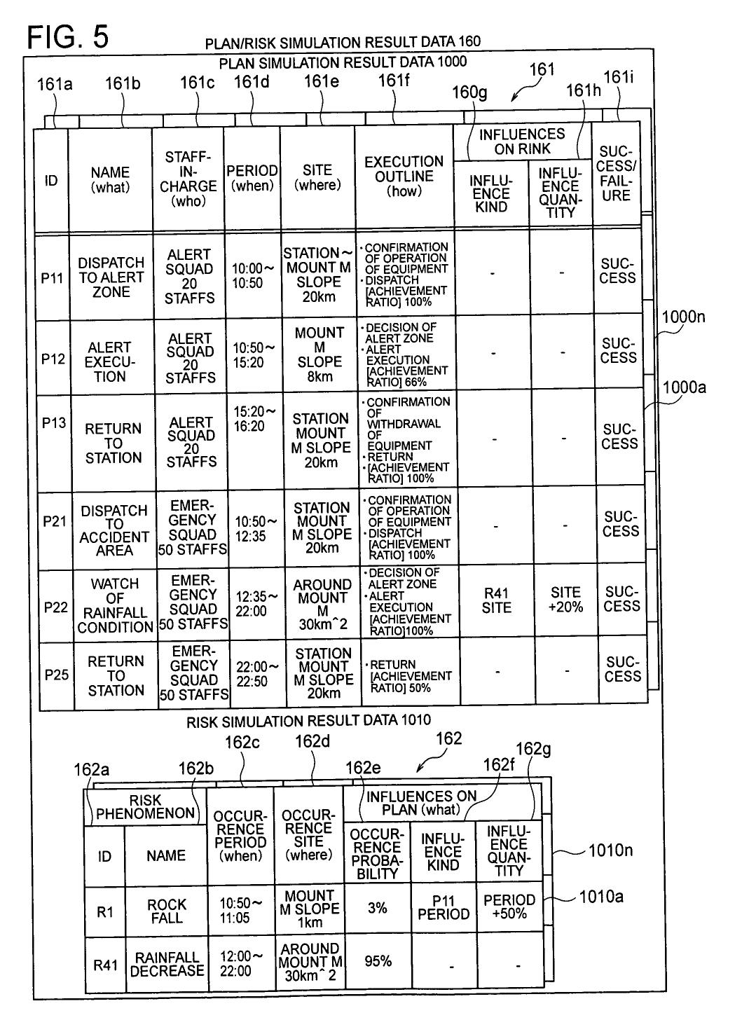

FIG. 5 schematically shows the data structure of the plan/risk simulation result data 160 in the first embodiment.

The plan/risk simulation result data 160 has plan simulation result data 1000 for storing the simulation result of the action plan and risk simulation result data 1010 for storing the simulation result of the risk scenario. In this embodiment, the simulation processing is executed in a predetermined number of times for the action plan data 140 and the risk scenario data 150. Therefore, the plan/risk simulation result data 160 stores the simulation result data 1000a to 1000n and the simulation result data 1010a to 1010n of the risk scenario corresponding to the number of times of simulation.

The plan simulation result data 1000 will be initially explained. The plan simulation result data 1000 has a plurality of entries 161a to 161i. Each entry 161a to 161i has “ID”, “name”, “persons in charge”, “period”, “site”, “execution outline”, “influences on risks (kind of influence, influence quantity)” and “success/failure judgment result”. The same data as the data other than the numerical values of the “ID”, the “name”, the “persons in charge”, the “period” and the “site” stored in the entries 161a to 161e are stored in the same field inside the action plan data 140. The numerical values of the “persons in charge”, the “period” and the “site” stored in the entries 161c to 161e are the numerical values acquired by the simulation processing for the partial plan.

The data of the “execution outline” stored in the entry 161f is the data representing the execution items for which the How process simulation result of the partial plan is successful and the achievement ratio of the partial plan.

The same data as the field having the same name inside the action plan data 140 is stored in the “influences on risks (kind of influences, influence quantity)” of the entries 161g and 161h. The data representing either the success or the failure of the partial plan is stored in the “success/failure judgment result” stored in the plan simulation result data 161.

The risk simulation result data 1010 will be subsequently explained. The risk scenario simulation result data 101 has a plurality of entries 162a to 162g. Each entry 162a to 162g stores “risk ID”, “name”, “occurrence period”, “occurrence site” and “influences on plans (occurrence probability, kind of influences, influence quantity)” of the risk phenomenon for which the simulation processing is executed in practice.

The same data as the data of the field having the same name field of the risk scenario data 150 are stored in the “risk ID”, the “name”, the “occurrence period”, the “occurrence site” and the “influences on plans (occurrence probability, kind of influences, influence quantity)” of entries 162a to 162g.

The data input processing executed by the plan/risk input processing portion 110 of the simulation apparatus 200 of this embodiment and examples of the input view will be explained subsequently with reference to FIGS. 6A and 6B.

FIGS. 6A and 6B typically show the action plan input view and the risk scenario input view displayed by the simulation apparatus of the first embodiment on the display device. FIG. 6A shows the action plan input view 600 and FIG. 6B shows the risk scenario input view 650.

The plan/risk input processing portion 110 of the simulation apparatus 200 accepts the input request (correction and deletion requests of the inputted data) and displays the action plan input view 600 on the display device 230 as shown in FIG. 6A.

The action plan input view 600 is the view for accepting new input of the action plan data 140 explained with reference to FIG. 3, correction of the inputted data and deletion of the inputted data. Incidentally, the input of the new data, the correction of the inputted data and the deletion of the inputted data will be called “edition” in the following description.

An action plan input area 610 for accepting the edition of the action plan data 140 and an area 680 having various buttons for accepting the instruction are arranged on the action plan input view 600. Each row of the action plan input area 610 corresponds to each partial plan and each column corresponds to the information of each partial plan such as the “ID”, the “name”, etc. (the information stored in the entries 140a to 1401 explained with reference to FIG. 3). Incidentally, the action plan input view 600 shown in the drawings represents the state where the planner 101 in charge of the partial plan P11 is inputting the data “alert squad, 20 staffs”.

As to the information among the action plan data 140 that is not displayed on the action plan input view 600 (such as partial plans having ID of P13 and so on, subsequent plan of each partial plan, influence risk ID, etc.), the plan/risk input processing portion 110 accepts the display request from the planner 101 and displays the corresponding data. For example, the plan/risk input processing portion 110 may accept the operation of the scroll bar on the action plan input view 600 from the planner 101 and may display the corresponding information.

The plan/risk input processing portion 110 can accept addition and deletion of the partial plans. When receiving the addition of the partial plan, the plan/risk input processing portion 110 accepts designation of the row from the planner 101 by using the pointer 601 and accepts the input of the data of the partial plan to be added. For example, the planner 101 can add a new partial plan by designating the row by using the pointer 601 and adding the row to thereby input the corresponding data to each cell of the partial plan added. Incidentally, to accept deletion of the partial plan, the plan/risk input processing portion 110 accepts designation of the row to be deleted and deletes the partial plan of the designated row.

When registering the data inputted to the action plan input area 610 to the simulation apparatus 200, the planner 101 pushes (clicks) a registration button 620 of the area 680 and instructs the simulation apparatus 200 to input the action plan data. When receiving the input instruction of the action plan data, the plan/risk input processing portion 110 stores the action plan data accepted into a predetermined area of the auxiliary storage device 240. When receiving the click of a cancel button 630 of the area 680 from the planner 101, on the other hand, the plan/risk input processing portion 110 cancels the action plan data so accepted.

A simulation button 631 and an evaluation result button 632 are arranged in the area 680 of the action plan input view 600. The simulation button 631 is the button for accepting the instruction of the start of the processing of simulation of the action plan and the risk scenario and the evaluation result button 632 is the button for accepting the instruction of the start of the evaluation processing of the action plan simulated.

When the planner 101 clicks the simulation button 631 and the instruction of the start of the simulation processing is accepted, the plan/risk input processing portion 110 instructs the plan/risk simulation processing portion 120 to start simulation. When receiving this instruction, the plan/risk simulation processing portion 120 starts simulation of the action plan and the risk scenario.

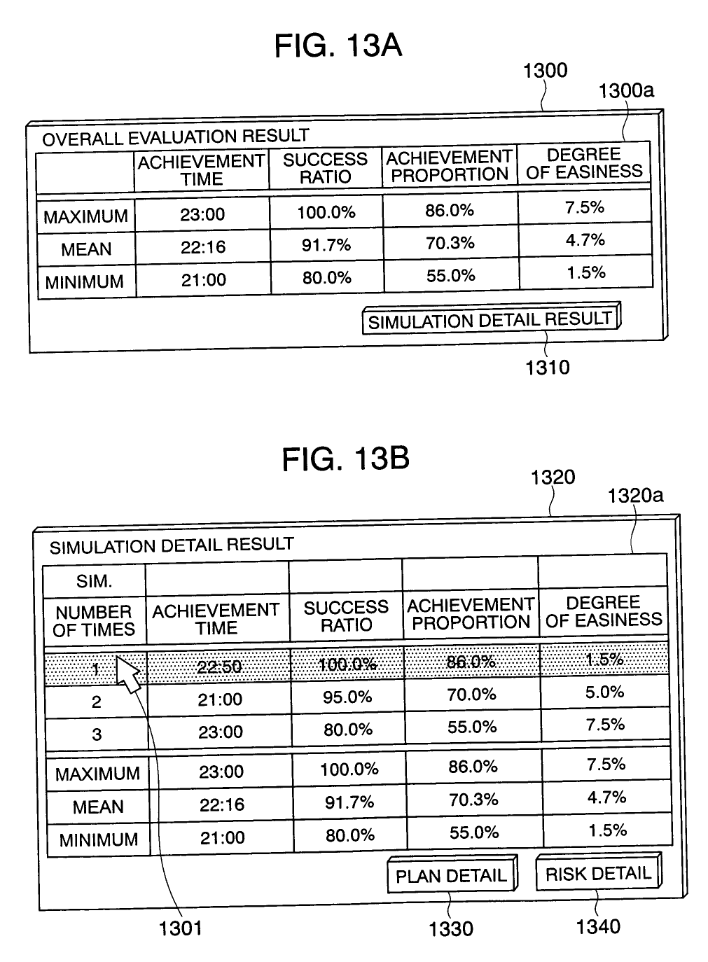

When accepting the instruction of the start of the evaluation processing of the action plan inputted when the planner 101 clicks the evaluation result button 632, the plan/risk input processing portion 110 instructs the plan evaluation output processing portion 130 to start the evaluation processing of the action plan. When receiving this instruction, the plan evaluation output processing portion 130 executes evaluation of the action plan and displays the evaluation result on the screen for displaying the evaluation result (see later-appearing FIG. 13A, for example) of the display device 230.

When receiving the input request of the risk scenario data inputted by the planner 101 through the input device 220 (or correction and deletion requests of inputted data), the plan/risk input processing portion 110 of the simulation apparatus 200 displays the risk scenario input view shown in FIG. 6B on the display device 230.

The risk scenario input view 650 is the view for accepting the edition (input of new data, correction of inputted data and deletion of inputted data) of the risk scenario explained with reference to FIG. 4.

A risk scenario input area 660 and an area 680 having various buttons for accepting the instruction are arranged on the risk scenario input view 650. Each row of the risk scenario input area 660 corresponds to each risk phenomenon and each column corresponds to information of each risk phenomenon (information stored in each entry 150a to 150i explained in FIG. 4). The risk scenario input view 650 shown in the drawing represents the state where the planner 101 is inputting data representing “for 6 hours from start of P22” to the occurrence period of the risk phenomenon R2.

As to the information that cannot be displayed fully on the risk scenario input view 650 among the risk scenario data 150 (risk phenomena after risk phenomenon having ID of R41, subsequent risk of each risk phenomenon, influence plan ID, etc. in the example shown in the drawing), the plan/risk input processing portion 110 accepts the operation of a scroll bar by the planner 101 and displays the corresponding information in the same way as in FIG. 6A described above.

The plan/risk input processing portion 110 can accept addition and deletion of the risk phenomenon in the same way as the partial plan of the action plan data 140. To accept the addition of the risk phenomenon, the plan/risk input portion 110 accepts designation of the row by the planner 101 through the pointer 601 and the input of the data of the risk phenomenon to be added. For example, the planner 101 designates the row to be added by using the pointer 601 and adds the new risk phenomenon. Incidentally, the plan/risk input processing portion 110 accepts designation of the row to be deleted and deletes the risk phenomenon of the designated row when receiving the deletion of the risk phenomenon.

To register the data inputted to the risk scenario input area 650 to the simulation apparatus 200, the planner 101 executes the processing similar to the input processing of the action plan data. In other words, the planner 101 pushes (clicks) the registration button 620 of the area 680 and instructs the simulation apparatus 200 to input the risk scenario data. When accepting the input instruction of the risk scenario data, the plan/risk input processing portion 110 stores the risk scenario data so accepted into the predetermined area of the auxiliary storage device 240. When accepting the click of the cancel button of the area 680 from the planner 10, on the other hand, the plan/risk input processing portion 110 cancels the risk scenario data accepted.

The simulation button 631 and the evaluation button 632 of the area 680 of the risk scenario input view 650 are the same as those arranged on the action plan input view 600 shown in FIG. 6A.

Incidentally, the action plan input view 600 and the risk scenario input view 650 are displayed by a table form in FIGS. 6A and 6B but this display form is merely illustrative. The action plan input view 600 and the risk scenario input view 650 may be displayed by other display forms. For example, the plan/risk input processing portion 110 displays the screen for inputting only the partial plan list as the action plan input view 600. When receiving designation of one partial plan on the list displayed, the plan/risk input processing portion 110 may display another view for inputting the 4W1H information of the partial plan accepted.

Next, the plan/risk simulation processing executed by the plan/risk simulation processing portion 120 of the simulation apparatus in this embodiment will be explained.

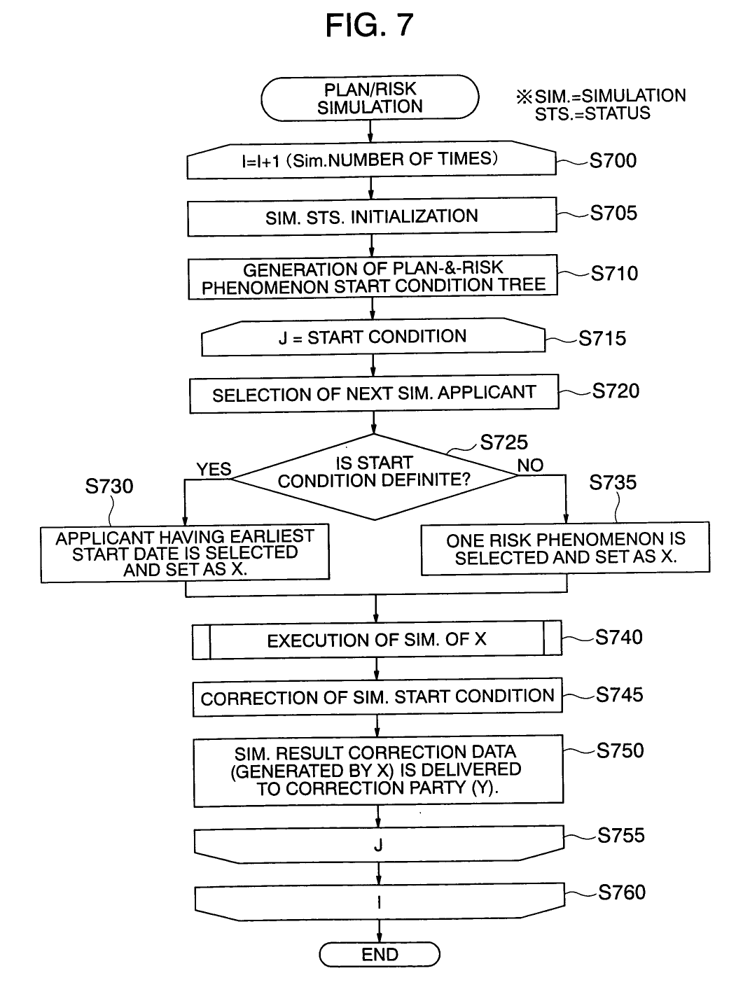

The overall processing flow of the plan/risk simulation processing executed by the plan/risk simulation processing portion 120 will be initially explained with reference to FIG. 7.

FIG. 7 is a flowchart useful for explaining the processing flow of the plan/risk simulation process in the first embodiment. Incidentally, the plan/risk simulation processing portion 120 in this embodiment executes a predetermined number of times simulation of the action plan and the risk scenario (S70). It will be assumed that data representing the number of times of simulation is stored in the predetermined area of the main storage device 250. A concrete procedure of a processing for accepting the data representing the number of times of simulation is not particularly limited. For example, the number of times of simulation may be accepted from the planner 101 through the input device 200 when the plan/risk simulation processing portion 120 starts the simulation processing. Alternatively, the data representing the number of times of simulation may be stored in advance as a default value in the auxiliary storage device 240 so that the plan/risk simulation processing portion 120 can read out the data representing the number of times of simulation to the main storage device 250.

When receiving the simulation start instruction from the planner 101, the plan/risk simulation processing portion 120 starts simulating the action plan and the risk scenario.

The plan/risk simulation processing portion 120 counts the number of times of simulation “I” and holds the number of times of simulation “I” counted in a predetermined area of the main storage device 250. More concretely, the plan/risk simulation processing portion 120 first sets “1” to the number of times of simulation “I”. The plan/risk simulation processing portion 120 thereafter adds “1” to the number of times of simulation “I” whenever the processing of S700 is repeated and holds the sum in the main storage device 250.

The plan/risk simulation processing portion 120 reads out the action plan data 140, the risk scenario data 150 and the plan/risk simulation result data 160 that are stored in the auxiliary storage device 240 to the main storage device 250. The plan/risk simulation processing portion 120 initializes the simulation state (S705). The term “initialization of the simulation state” means erasure of the data stored in each entry of the plan/risk simulation result data 160 so read out.

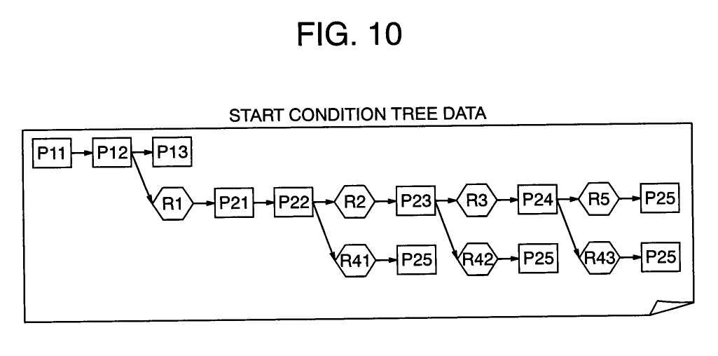

The plan/risk simulation processing portion 120 subsequently generates a start condition tree defining the start condition of simulation of each partial plan and each risk phenomenon (S710). The start condition tree is the data representing in which order each partial plan and each risk phenomenon are simulated. A concrete construction of the start condition tree is not limited in this embodiment and includes an execution time series tree of the partial plans and an occurrence time series tree of the risk phenomena (or their combination). More concretely, the plan/risk simulation processing 120 generates the start condition tree by using the action plan data 140 and the risk scenario data 150 that are read out. FIG. 10 shows the start condition tree generated by the plan/risk simulation processing portion 120 by using the action plan data 140 shown in FIG. 3 and the risk scenario data 150 shown in FIG. 4. FIG. 10 typically shows the start condition tree of the plan/risk simulation processing in the first embodiment. The start condition tree shown in this drawing represents the start condition by combining the partial plan with the risk phenomenon.

Explanation will be continued by turning back to FIG. 7. After the processing of S705, the plan/risk simulation portion 120 executes the following simulation processing phases (S715 to S755) by using the start condition tree generated. In the phases, the plan/risk simulation processing portion 120 first selects (S715, S720) an execution applicant (partial plan or risk phenomenon) of next simulation by using the start condition tree generated in S710 and proceeds to the processing of S725.

In S725, the plan/risk simulation processing portion 120 judges whether or not the start condition of the execution applicant (partial plan or risk phenomenon) of the next simulation selected in S720 is definite. The flow proceeds to S730 when the plan/risk simulation processing portion 120 judges that the start condition of the execution applicant of the selected simulation is definite. On the other hand, the flow proceeds to S735 when the plan/risk simulation processing portion 120 judges that the start condition of the execution applicant of the next selected simulation is not fully definite.

In S730, the plan/risk simulation processing portion 120 selects the execution applicant (partial plan or risk phenomenon) having the earliest simulation start date among the execution applicants the start condition of which is definite, and specifies the selected partial plan or risk phenomenon as the simulation object (hereinafter called “simulation object X”), and the flow proceeds to S740. Incidentally, the state where the start condition of the partial plan or the risk phenomenon is definite represents the case where the start condition (time, in this embodiment) is designated by the absolute numerical value as the partial plans P11, 12 and 13 in FIG. 3, for example.

In S735, the plan/risk simulation processing portion 120 selects one risk phenomenon and proceeds to the processing of S740 by setting the selected risk phenomenon to the next “simulation object X”. Incidentally, the state where the start condition of the partial plan or the risk phenomenon is not fully definite represents the case where the start condition (time, in this embodiment) is relatively designated and the partial plan and the risk phenomenon mutually refer to the start time as in the partial plan 23 shown in FIG. 3 and in the risk phenomena R3 and R42 shown in FIG. 4, for example.

In other words, in the case where the partial plan P23 and the risk phenomena R3 and R42 are the applicants of the next simulation, the start time of the partial plan P23 designates the start time of P23 itself and the simulation start time cannot be specified by the start condition of P23 alone. On the other hand, the start time of the risk phenomena R3 and R42 refers to the start time of the partial plan P2, too, and the simulation start time of P23 cannot be specified even when the start condition of the risk phenomena R3 and R42 is additionally taken into consideration. Such a case corresponds to “the state where the start condition is not definite”. Under this state, one risk phenomenon is first selected and its simulation is executed. This state assumes the case in an alert project where the risk phenomenon varies with people or an organization. For example, it assumes the condition where “next action is changed depending on what move both guards and intruders will make”, for example.

Subsequently, the plan/risk simulation processing portion 120 executes in S740 the simulation processing for the simulation object X selected in S730 or S735. Incidentally, the simulation processing executed in S740 will be described later.

After executing simulation of the partial plan or the risk phenomenon in S740, the plan/risk simulation processing portion 120 corrects each start condition of the partial plan and the risk phenomenon inside the start condition tree on the basis of the execution result (S745). The correction of each start condition inside the tree that is executed by the plan/risk simulation processing portion 120 will be explained about the risk phenomenon R5 shown in FIG. 4 by way of example. When the start condition is relatively designated as the risk phenomenon R5, for example, the absolute date of the occurrence of R3 becomes definite and the start condition of R5 becomes consequently definite when the plan/risk simulation processing portion 120 finishes simulation of the reference destination (R3, in this case). The plan/risk simulation processing portion 120 changes the start condition of R5 from the relative date to the absolute date.

The plan/risk simulation processing portion 120 executes in S740 a processing for reflecting the execution result of simulation of the partial plan or risk phenomenon X on other partial plans or risk phenomena. Here, other partial plans or risk phenomena that are affected by the simulation processing for the “simulation object X” will be called “simulation object Y”.

The plan/risk simulation processing portion 120 delivers correction data (that will be later described) contained in the simulation result of the simulation object X to the “simulation object Y” (S750). More concretely, the plan/risk simulation processing portion 120 stores data representing influences on other partial plans (or other risk phenomena) that will occur when the simulation object X is executed (or occurs) as correction data in the plan/risk simulation result data 160. The plan/risk simulation processing portion 120 stores the data representing the influences in the plan/risk simulation result data 160 only when the result of the simulation processing of the “simulation object X” affects the other simulation objects. In S750, the plan/risk simulation processing portion 120 stores data representing the simulation result other than the correction data acquired by the simulation processing that is executed in S740.

Next, the plan/risk simulation processing portion 120 judges by using the start condition tree whether or not the simulation execution applicant next to the partial plan (or the risk phenomenon) executed in S740 exists (S755). The flow returns to the processing of S715 when the plan/risk simulation processing portion 120 judges that the next simulation execution applicant exists. The flow proceeds to the processing of S760, on the other hand, when the plan/risk simulation processing portion 120 does not judge that the next simulation execution applicant exists.

In S760, the plan/risk simulation processing portion 120 judges whether or not the number of times of simulation “I” set in S700 is less than the number of times of simulation that is designated in advance. The plan/risk simulation processing portion 120 returns to the processing of S700 when the number of times of simulation “I” is less than the number of times of simulation designated in advance as a result of judgment and finishes the processing at other times.

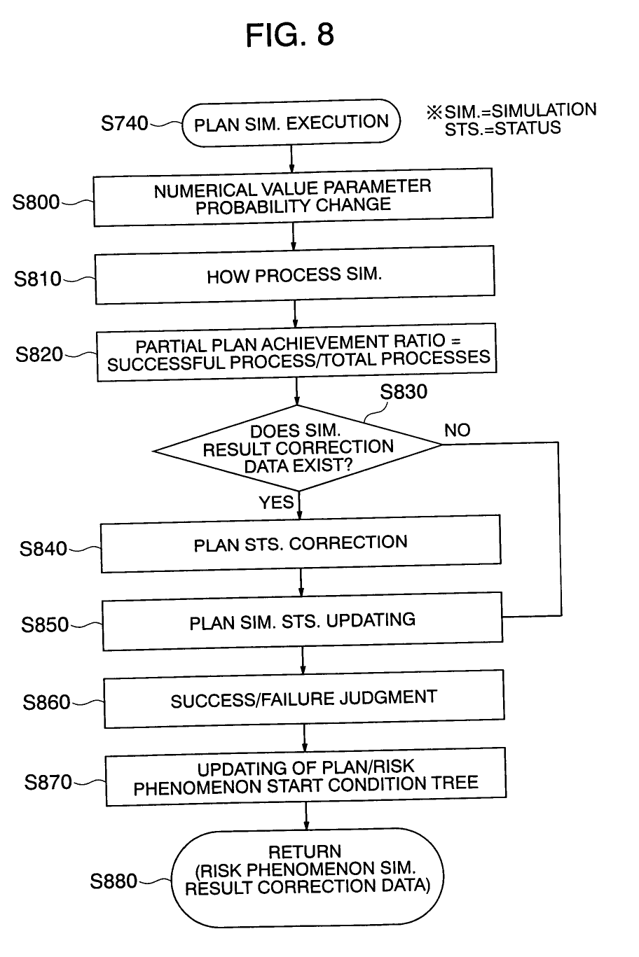

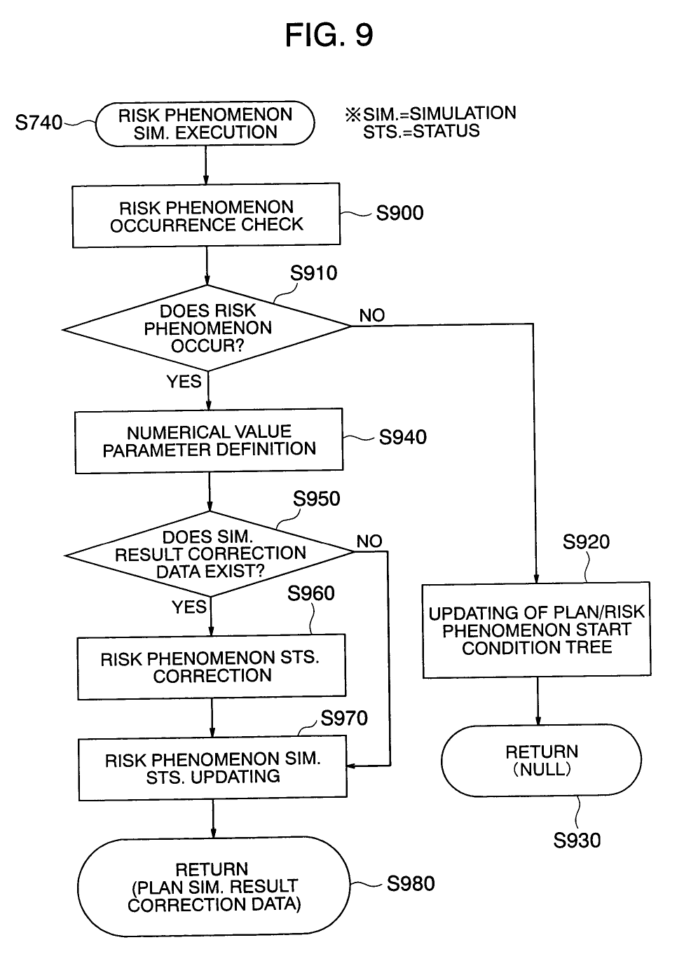

Subsequently, the simulation processing executed in S740 shown in FIG. 7 will be explained in detail with reference to FIGS. 8 and 9.

FIG. 8 is a flowchart useful for explaining the processing flow of the simulation processing for the action plan in the first embodiment of the invention. FIG. 9 is a flowchart useful for explaining the processing flow of the simulation processing for the risk scenario in the first embodiment of the invention.

First, the processing flow of the simulation processing for the action plan shown in FIG. 8 will be initially explained. The following processing shown in the drawing is the one that is executed when the simulation object X is the partial plan in S740 in FIG. 7. More concretely, the plan/risk simulation processing portion 120 starts processing S800 and so forth in S740 when the simulation object X selected in S730 in FIG. 7 is the partial plan.

In S800, the plan/risk simulation processing portion 120 causes a probability change of the data designated by the numerical value parameter in the 4W1H information of the partial plan selected as the simulation object X. Here, the probability change will be explained about the case where the probability change of the partial plan to which “ID” of “P11” is allocated in the action plan data 140 shown in FIG. 3 is made.

The plan/risk simulation processing portion 120 executes the probability change processing for 1 hour of “10:00 to 11:00” defined as the numerical value parameter for the “period” of “P11” and changes the “period” to 50 minutes of “10:00 to 10:50”, for example. Similarly, the plan/risk simulation processing portion 120 changes probability-wise the data designated by the numerical value among the “persons in charge”, the “site”, and so forth. Any probability changing method may be used in this embodiment. For example, the data may be changed in accordance with the normal distribution that uses the numerical value inputted (1 hour of “10:00 to 11:00” in the example described above) as the mean value and the numerical value of n % of the inputted numerical value as standard deviation. The data may be changed at random by separately determining the maximum value and the minimum value.

Next, the plan/risk simulation processing portion 120 executes simulation of the execution outline (How) process of the data of the specified partial plan (S810) and calculates the partial plan achievement ratio from the proportion of success of each execution item constituting the How process (S820).

Next, simulation of the execution outline (How) process will be explained about the example of the execution outline of the partial plan having the “ID” of “P12” among the action plan data 140 shown in FIG. 3. The execution outline (How) defined in “P12” is three items of “alert zone decision”, “alert execution” and “status report”. The plan/risk simulation processing portion 120 decides at random whether simulation proves successful or failure for each execution item defined in the execution outline. The plan/risk simulation processing portion 120 calculates the achievement ratio of the execution outline by using the result so decided. For example, the plan/risk simulation portion 120 decides by the processing S810 that two items of “alert zone decision” and “alert execution” are successful. The plan/risk simulation processing portion 120 calculates from this decision the achievement ratio of 66% (in other words, success of the only two items of the three items; ⅔ approx. 66%).

In this embodiment, the example that decides whether each execution item defined in the execution outline is successful or failure is explained as an example of the simulation method of the How process. However, the embodiment is not particularly limited to this method but may use other methods. For example, it is possible to separately define the sequence limit among the execution items and to conduct simulation as a work flow (unless the “alert zone decision” is made, other items cannot automatically be conducted).

Subsequently, the plan/risk simulation processing portion 120 judges the existence/absence of the correction data of the simulation result (hereinafter called “correction data”) that is delivered in S750 shown in FIG. 7 (S830). The plan/risk simulation processing portion 120 proceeds to the processing of S840 when the correction data exists and to the processing of S850 when the correction data does not exist. The term “correction data” represents the data that are stored in the entries 162e to 162f of the risk simulation result data 1010 of the plan/risk simulation result data 160 shown in FIG. 5. By referring to the data stored in the entries 162e to 162g of the risk simulation result data 1010, the plan/risk simulation processing portion 120 judges the existence/absence of the correction data for the partial plan that is now processed.

In S840, the plan/risk simulation processing portion 120 conducts correction of the probability change of the numerical value parameters and the simulation result in accordance with the corresponding correction data stored in the entries 162e to 162g of the risk simulation result data 1010 and then proceeds to the processing of S850. Here, the probability change result of the numerical value parameters means the change result of the number of persons in charge, time, distance, etc. inside the action plan data 140 and the simulation result means further correction of this probability change result on the basis of the kind of influences and the influence quantity inside the risk scenario data 150.

In S850, the plan/risk simulation processing portion 120 defines the simulation result of the partial plan (updates the status) and then proceeds to the processing of S860. More concretely, the plan/risk simulation processing portion 120 defines the data obtained in S800 to S820 as the simulation result of the partial plan when the correction data is judged as being absent in S830. On the other hand, the plan/risk simulation processing portion 120 defines the data obtained in S810 to S820 and S840 as the simulation result of the partial plan when the correction data is judged as being present in S830.

The probability change result and the failure standard inside the action plan data 140 are compared and whether the partial plan is successful or failed is judged (Step S860). When the judgment proves failure, updating for deleting subsequent partial plans and subsequent risk phenomena from the start condition tree that are executed after the partial plan now under processing is executed (Step S870).

Finally, the plan/risk simulation processing portion 120 stores the data representing the influences occurring due to the execution of the partial plan now underway on other risk phenomena (data stored in the entry 140h of the action plan data 140) and the data representing the simulation result described above in a predetermined area of the main storage device 250 and then returns to the processing of S745 (S880).

The flow of the simulation processing for the risk scenario in the embodiment shown in FIG. 9 will be explained.

The following processing shown in the drawing is the processing that is executed when the simulation object X is the risk phenomenon. More concretely, the plan/risk simulation processing portion 120 executes in S740 the processing of S900 and so forth when the simulation object X selected in S730 in FIG. 7 is the risk phenomenon and when the risk phenomenon is selected in the processing of S735.

The plan/risk simulation processing portion 120 first judges whether or not the risk phenomenon occurs by using the occurrence probability inside the risk scenario data 150 S900, 910).

When judging that the selected risk phenomenon does not occur in S910, the plan/risk simulation processing portion 120 executes updating to delete the subsequent risk phenomena and partial plans occurring after the risk phenomenon under simulation processing from the start condition tree (S920) and then returns (S930).

When judging that the selected risk phenomenon occurs in S910, the plan/risk simulation processing portion 120 employs as the definite value the information among the 3W information designated by the numerical value parameter inside the risk phenomenon data (S940).

Subsequently, the plan/risk simulation processing portion 120 judges the existence/absence of the correction data as the simulation result delivered in S750 shown in FIG. 7 (S950). The plan/risk simulation processing portion 120 proceeds to the processing of S960 when the correction data exists and to the processing of S970 when the correction data does not exist. Incidentally, the correction data means the data stored in the entries 161g to 161h of the plan simulation result data 1000 of the plan/risk simulation result data 160.

The plan/risk simulation processing portion 120 corrects the corresponding data in the data defined in S940 when the correction data exists (Step S960) and updates the status as the simulation result of the risk phenomenon. On the other hand, the plan/risk simulation processing portion 120 updates the status as the simulation result of the data defined in S940 when the correction data does not exist (Step S970). Because the concrete procedures of S950 to S970 are the same as those of S830 to S850 shown in FIG. 8, explanation will be omitted.

Finally, the plan/risk simulation processing portion 120 executes the processing for reflecting the correction data when the risk phenomenon under processing affects other partial plans, and returns to the processing shown in FIG. 7 (Step S980). Incidentally, because the concrete procedure of S980 is similar to the processing of S880 shown in FIG. 8, explanation will be omitted.

In this embodiment, the influence of the partial plan on the risk phenomenon typically represents the change of the “site” (see FIG. 3) and the influence of the risk phenomenon typically represents the changes of the “period”, the “site” and the “persons in charge” (see FIG. 4). However, the influences are not limited in the invention. For example, the influences of the risk phenomenon on other factors such as correction of the occurrence period can be reflected by additionally defining the kind of influences and the influence quantity on the risk phenomenon.

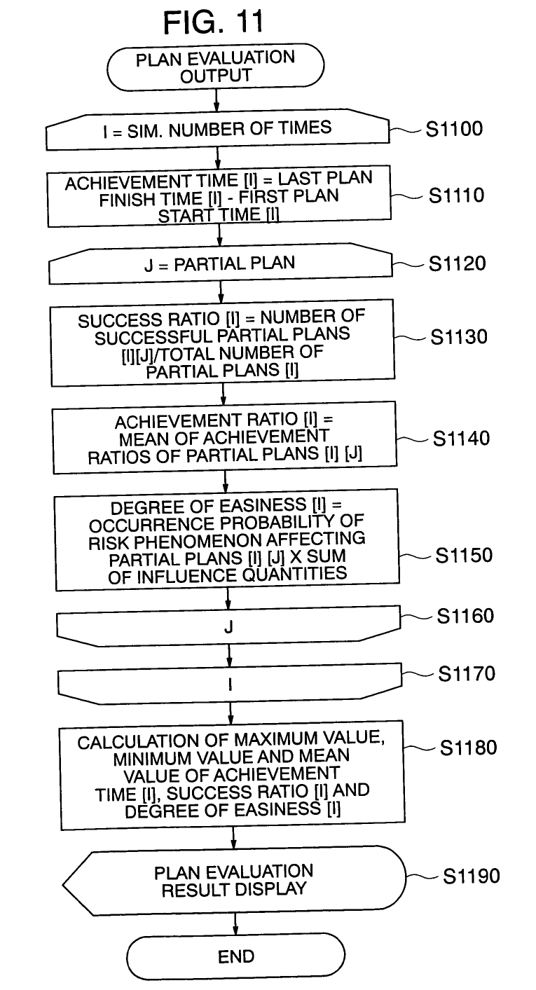

The plan evaluation output processing executed by the plan evaluation output processing portion 130 of the simulation apparatus according to this embodiment will be subsequently explained with reference to FIG. 11.

FIG. 11 is a flowchart useful for explaining the processing flow of the plan evaluation output processing in this embodiment. In the plan evaluation output processing that will be explained next, the evaluation result of the “achievement time”, the “success ratio”, the “achievement proportion” and the “degree of easiness” is calculated the number of times of simulation executed by the plan/risk simulation processing portion 120 (S1100 to 1170).

The plan/evaluation output processing portion 130 first counts the number of times of simulation “I” and stores the number of times of simulation “I” so counted in the predetermined area of the main storage device 250 (S1100). More concretely, the plan evaluation output processing portion 130 initially sets “1” to the number of times of simulation “I”. The plan evaluation output processing portion 130 thereafter adds “1” to the number of times of simulation “I” set whenever the processing of S1100 is repeated, and stores the sum in the predetermined area of the main storage device 250. The plan evaluation output processing portion 130 executes the following processing S1100 to S1170 to be explained below by using the simulation result that is executed the Ith time set as described above.

Next, the plan evaluation output processing portion 130 calculates the achievement time from the start time of the partial plan executed first and the finish time of the partial plan executed last by using the plan/risk simulation result data 160 (S1110).

The plan evaluation output processing portion 130 subsequently calculates the success ratio, the achievement proportion and the degree of easiness from the simulation result for each partial plan and proceeds to S1170 (S1120 to S1160). More concretely, the plan evaluation output portion 130 calculates the success ratio from the number of the successful partial plans and the number of the partial plans of the whole action plan in S1130. In S1140, the plan evaluation output processing portion 130 calculates the achievement proportion by averaging the achievement ratio of each partial plan. In S1150, the plan evaluation output processing portion 130 calculates the degree of easiness from the product of the occurrence probability of the risk phenomena that may affect each partial plan and the influence quantity.

In S1170, the plan evaluation output processing portion 130 judges whether or not the number of times of simulation “I” set in S1110 is less than the number of times of simulation that is in advance designated. In other words, the plan evaluation output processing portion 130 judges whether or not the number of times of simulation “I” is less than the number of times of simulation that is carried out in practice. The plan evaluation output processing portion 130 returns to the processing of S1100 when the number of times of simulation “I” set is less than the number of times of simulation carried out in practice, and proceeds to the processing of S1180 at other times.

In S1180, the plan evaluation output processing portion 130 calculates the maximum value, the minimum value and the mean value throughout the entire number of times of simulation for each of the achievement time, the success ratio, the achievement proportion and the degree of easiness that are individually determined for each number of simulation. Incidentally, the plan evaluation output processing portion 130 stores the data acquired in S1110 to S1150 (“achievement time”, “success ratio”, “achievement proportion” and “degree of easiness”) and the data obtained above (“maximum value”, “minimum value” and “mean value”) as the evaluation result data 170 into the auxiliary storage device 240.

Finally, the plan evaluation output processing portion 130 displays the view (plan evaluation view) representing as a whole the action plan on the display device 230 by utilizing the calculated data (plan evaluation result data) described above (S1190).

Incidentally, the method of calculating the achievement time, the success ratio, the achievement proportion and the degree of easiness is not particularly limited in this embodiment. For example, the calculation method of the achievement proportion is not a mere arithmetic mean but may use the weighted arithmetic mean using the execution item number contained in the execution outline of each partial plan. Though the maximum value, the minimum value and the mean value are calculated as the evaluation values of the entire action plan in this embodiment, other evaluation methods may be used, too. For example, mean and dispersion may be determined as the evaluation value and the numerical value distribution chart or graph of the simulation result may be displayed.

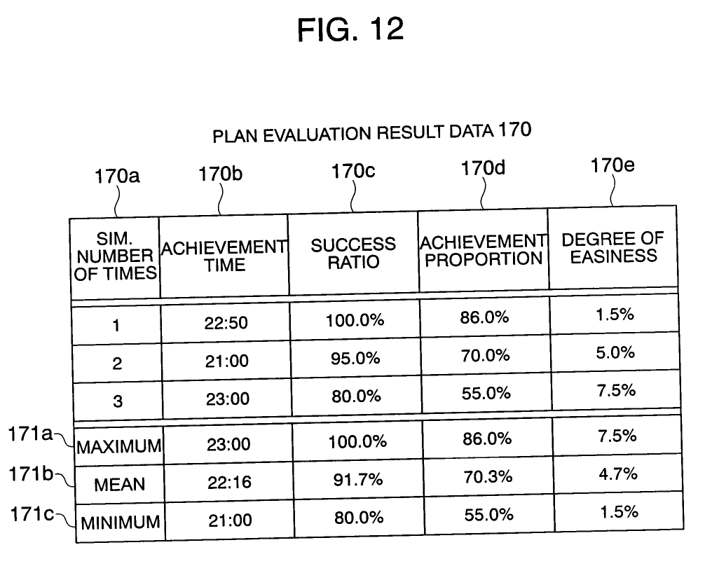

Next, the plan evaluation result data 170 calculated by the plan evaluation output processing portion 130 will be explained with reference to FIG. 12.

FIG. 12 schematically shows the data structure of the plan evaluation result data 170 in this embodiment.

The plan evaluation result data 170 has entries 170a to 170e for storing “number of times”, “achievement time”, “success ratio”, “achievement proportion” and “degree of easiness” for each number of time of simulation that are determined by the plan evaluation output processing portion 130 and entries 171a to 171c for storing “maximum value”, “minimum value” and “mean value” throughout the entire number of times of simulation determined by the plan evaluation output processing portion 130.

The plan evaluation screen displayed by the plan evaluation output processing portion 130 in this embodiment on the display device 230 will be explained with reference to FIGS. 13A and 13B.

FIGS. 13A and 13B typically show the plan evaluation screen displayed by the plan evaluation output processing portion 130 in this embodiment. FIG. 13A shows the whole evaluation result view 1300 schematically representing the whole evaluation and FIG. 13B shows the simulation detailed result view 1320 representing the detailed content of the simulation result.

An area 1300a for displaying the maximum value, the minimum value and the mean value of each of the “achievement time”, the “success ratio”, the “achievement proportion” and the “degree of easiness” as the entire evaluation result of the action plan among the plan evaluation result data 170 and a simulation result detail button 1310 for accepting the display of the simulation detailed result are arranged on the whole evaluation result view 1300. The plan evaluation output processing portion 130 shifts the display view to the simulation detailed result view 1320 shown in FIG. 13B when it accepts selection of the simulation result detail button 1310 on the whole evaluation result view 1300.

An area 1320a for displaying also the achievement time, the success ratio, the achievement proportion and the degree of easiness for each number of times of simulation among the plan evaluation result data 170 is arranged on the simulation detailed result view 1320 in addition to the display content of the whole evaluation result view 1300. Therefore, a more detailed simulation result can be offered in accordance with the request from the planner 101.

A plan detail button 1330 and a risk detail button 1340 are further arranged on the simulation detailed result view 1320. The plan detail button 1330 accepts display of the simulation result of the action plan for each number of times of simulation. The risk detail button 1340 accepts display of the simulation result of the risk scenario for each number of times of simulation.

It will be assumed that the plan evaluation output processing portion 130 first accepts designation of the number of times of simulation by using the pointer 1301 on the simulation detailed result view 1320, or the like, and then accepts selection of the plan detail pointer 1330. In this case, the plan evaluation output processing portion 130 displays a view (not shown) representing the result of the corresponding action plan simulation on the display device 230 by using the plan/risk simulation result data 160.

It will be further assumed that the plan evaluation output processing portion 130 first accepts designation of the number of times of simulation by using the pointer 1301 on the simulation detailed result view 1320, or the like, and then accepts selection of the risk detail button 1340. In this case, the plan evaluation output processing portion 130 displays a view (not shown) representing the simulation result of the corresponding scenario on the display device 230 by using the plan/risk simulation result data 160.

As described above, the plan/risk input processing portion 110 in this embodiment displays the action plan input view 600 and the risk scenario input view 650 that are typically shown in FIG. 6A, on the display device 230. The plan/risk input processing portion 110 accepts the input of the action plan data 140 having the data structure typically shown in FIG. 3 and the input of the risk scenario data 150 having the data structure typically shown in FIG. 4.

Therefore, this embodiment can define the action plans of diversified fields for the action plans as the evaluation object project without particularly limiting the fields to which the whole or each partial plan belongs. This embodiment can also define the risk phenomena of diversified kinds for the risks that may affect the evaluation object project without particularly limiting the kinds of the risks.

Further, this embodiment conducts simulation of the action plan by reflecting the influences of the whole or any of the “4W1H information” (plan name information, person-in-charge information, period information, site information and execution outline information) contained in the partial plan information given by the risk phenomena on the information. Therefore, even when the risk phenomenon occurs during the execution process of the action plan, simulation can be made while the status that affects the partial plan is reflected.

In this embodiment, simulation of the risk phenomenon is conducted by reflecting the influences given by the action plan on the whole or any of the occurrence period information and the occurrence site information of the risk phenomenon and the action plan. Therefore, the change of the occurrence condition of the risk phenomenon due to the execution of the action plan can be simulated during the execution process of the action plan.

When the whole or any of the plan name information, the person-in-charge information, the period information, the site information and the execution outline information contained in the partial plan information is designated by the numerical value in the simulation of the action plan, the numerical value is changed probability-wise in this embodiment. Therefore, this embodiment can simulate the condition where each partial plan is affected by the cause that cannot be anticipated in advance.

This embodiment judges the success or failure of the partial plan and suspends the simulation of the succeeding plans when the partial plan is judged as failure. Therefore, the embodiment can simulate the shift of the action plan containing works mainly based on the possibility of failure due to external risk factors such as the field of risk management.

As described above, this embodiment conducts simulation by reflecting the mutual influences on one another when conducting simulation of the action plan and the risk scenario.

Therefore, even in the case of the project of the type in which WBS is changed due to the influences of the external risk factors (risk phenomena) this embodiment can conduct simulation while reflecting the influences given from the external factors.

In the embodiment, the plan evaluation output processing portion 130 displays the maximum value, the mean value, the minimum value and the detailed simulation result as the basis of calculation for each of the achievement time, the success ratio, the achievement proportion and the degree of easiness as the approval/rejection judgment reference by the whole evaluation result view 1300 and the simulation detailed result view 1320.

Therefore, even in the case of the project of the type in which WBS is changed due to the influences of the external risk factors (risk phenomena) the embodiment can offer the simulation result for judging the approval/rejection of the action plan.

### Second Embodiment

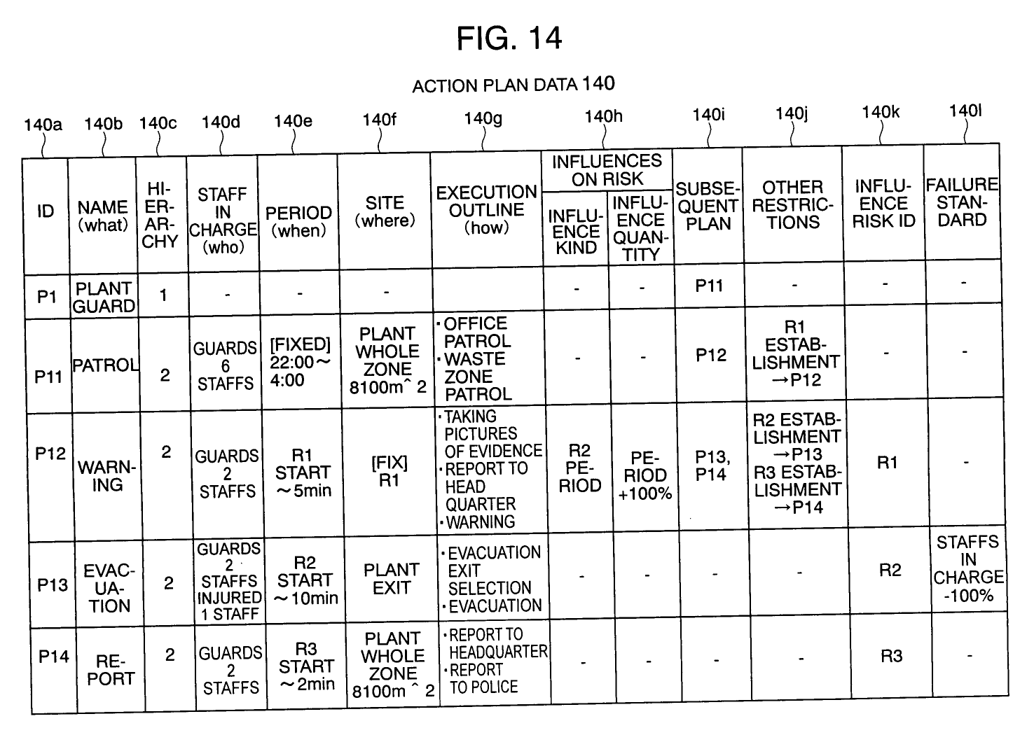

The second embodiment of the invention will be subsequently explained with reference to FIGS. 14 to 19. The second embodiment additionally has the function of evaluating the approval/rejection of the project that may be affected by the risk phenomena occurring due to the human factors such as people or organizations in addition to the functions of the simulation apparatus 200 of the first embodiment. The second embodiment can execute evaluation of a plan improvement proposition by arbitrarily fixing the numerical value parameters (numerical value data in the “4W1H” information shown in FIG. 3) for simulation contained in the action plan data. The simulation apparatus according to the second embodiment can also change the probability for the numerical value parameters for simulation contained in the risk scenario, too. Incidentally, like reference numerals are used in the second embodiment to denote like constituents. The second embodiment will be explained about a trespasser alert project for a plant as the simulation object program by way of example.

The hardware construction, the flow of processing, the data construction and the view construction of the second embodiment are hereby assumed to be the same as those of the first embodiment. More concretely, the functional construction of the simulation apparatus of the second embodiment is the same as that of the first embodiment shown in FIG. 1 with the exception that a part of the simulation processing of the action plan data and the risk scenario data executed by the plan/risk simulation processing portion 120 is different. The simulation apparatus 200 of the second embodiment stores the action plan data 140, the risk scenario data 150, the plan/risk simulation result data 160 and the plan evaluation result data 170 in the same way as in the first embodiment. The data construction is also the same except that a part of each of the action plan data 140 and the risk scenario data 150 is different. The hardware construction of the second embodiment is the same as the one shown in FIG. 2. The following explanation will be primarily given on those that are different from the first embodiment.

The action plan data 140 in the second embodiment will be given initially with reference to FIG. 14.

FIG. 14 schematically shows the data structure of the action plan data 140 in the second embodiment.

As shown in the drawing, the action plan data of the second embodiment has the entries 140a to 1401 in the same way as the first embodiment shown in FIG. 3 and each entry 140a to 1401 stores the field in the same way as shown in FIG. 3. More concretely, “ID”, “name (what)”, “hierarchy”, “persons-in-charge (who)”, “period (when)”, “site (where)”, “execution outline (how)”, “influences on risk”, “subsequent plans”, “other restrictions”, “influence risk ID” and “failure standard” are stored in the entries 140a to 1401 of the action plan data 140.

The action plan data 140 in the second embodiment is different from that of the first embodiment in that a fix flag for inhibiting the probability change can be set to the information designated by the numerical value among the 4W1H information inside each partial plan. In FIG. 14, the flag for inhibiting the probability change is set to the data representing the period of the partial plan having “ID” of “P11”, for example. When conducting simulation of the partial plan having the “ID” of “P11”, the plan/risk simulation processing portion 120 conducts simulation by fixing the numerical value parameter without making the probability change for the period.

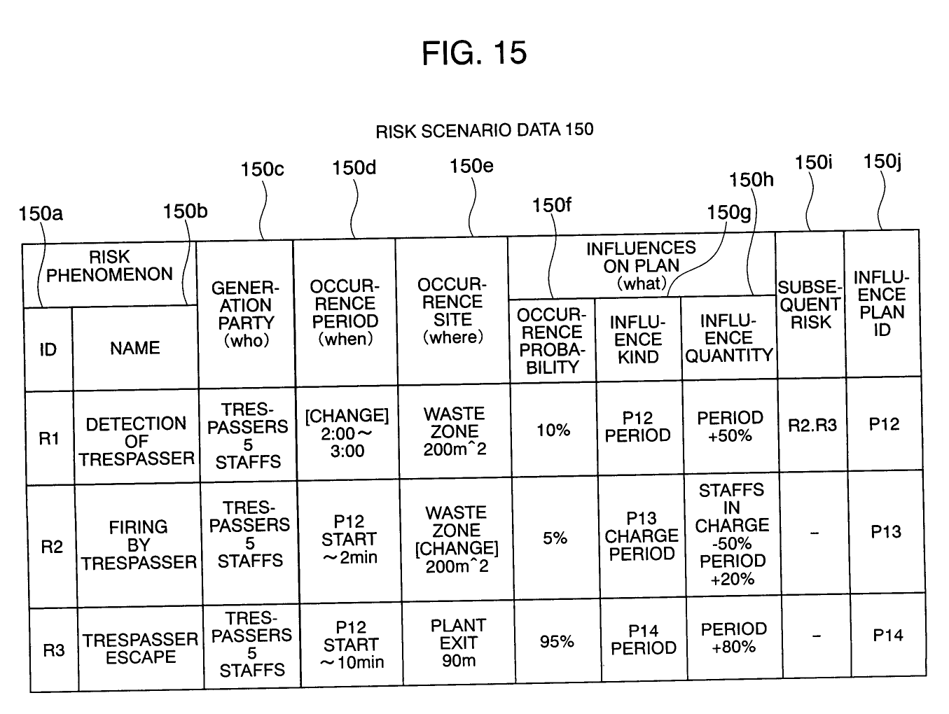

Subsequently, the risk scenario data 150 of the second embodiment will be explained with reference to FIG. 15.

FIG. 15 schematically shows the data structure of the risk scenario data 150 according to the second embodiment. The risk scenario data 150 of the second embodiment additionally has generation party information of the risk phenomenon in the same field of the risk scenario data of the first embodiment. The term “generation party information” means the information representing the generation party that generates the risk phenomenon.

The risk scenario 150 of the second embodiment has the entries 150a to 150j the number of which is greater by 1 than in the first embodiment as shown in the drawing. Each entry 150a to 150j stores the risk phenomenon generation party information (generation party) in addition to the same field as that of FIG. 4. More concretely, each entry 150a to 1501 of the action plan data 150 stores “risk ID”, “name”, “generation party (who)”, “occurrence period (when)”, “occurrence (where)”, “occurrence probability (what)”, “kind of influence (what)”, “influence quantity (what)”, “subsequent risk” and “influence plan ID”.

The second embodiment can explicitly define “who” generates the risk phenomenon in addition to the “3W” information defined by the risk scenario data 150 of the first embodiment. These kinds of information will be altogether called “4W”.

The risk scenario data 150 of the second embodiment is different from the risk scenario data 150 of the first embodiment in that a change flag for designating the probability change can be set to the information designated by the numerical value parameter among the 4W information inside each risk phenomenon. In the example shown in the drawing, the change flag for designating the probability change is set to the data representing the occurrence period of the risk phenomenon having “risk ID” of “R1”. When conducting simulation of the risk phenomenon having the “risk ID” of “R1”, the plan/risk simulation processing portion 120 conducts simulation by changing probability-wise the occurrence period.

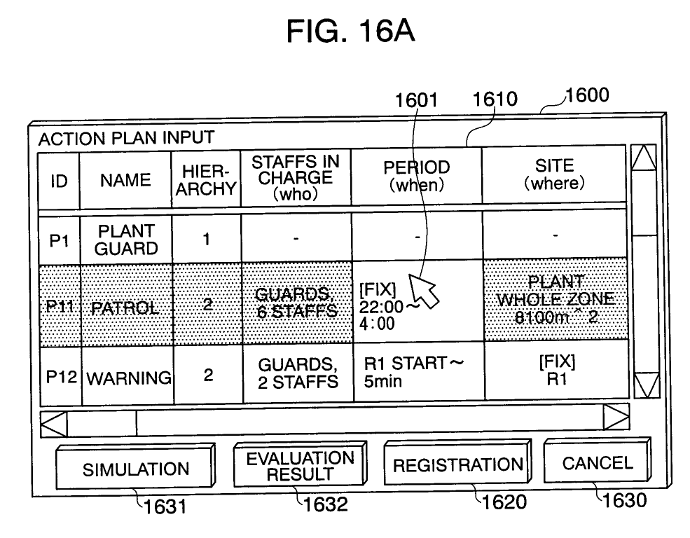

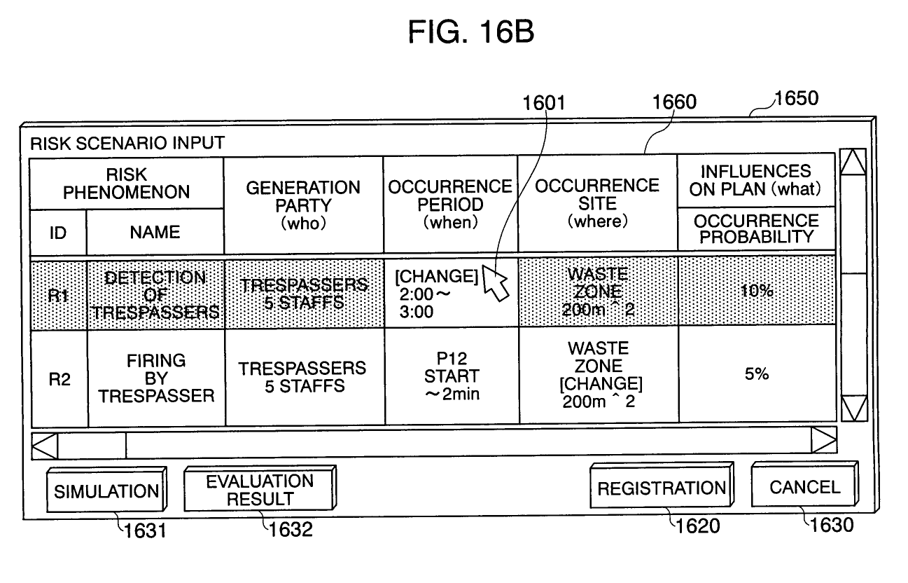

The action plan input view and the risk scenario input view in the second embodiment will be subsequently explained with reference to FIGS. 16A and 16B.

FIGS. 16A and 16B typically show the action plan input view and the risk scenario input view which the simulation apparatus of the second embodiment displays on the display device. FIG. 16A shows the action plan input view and FIG. 16B shows the risk scenario input view.

The action plan input view 1600 and the risk scenario input view 1650 shown in the drawings have the same user interface as the action plan input view 600 and the risk scenario input view 650 of the first embodiment shown in FIGS. 6A and 6B but are different from the latter in that they respectively can set a fix flag for the action plan data 140 and a change flag for the risk scenario data 150. The examples shown in FIGS. 16A and 16B represent the state where the fix flag is set to the period of the partial plan P11 in the action plan input view 1600 and the state where the change flag is set to the occurrence period of the risk phenomenon R1 in the risk scenario input view 1650.

The plan/risk simulation processing executed by the plan/risk simulation processing portion 120 of the simulation apparatus 200 of the second embodiment will be explained subsequently.

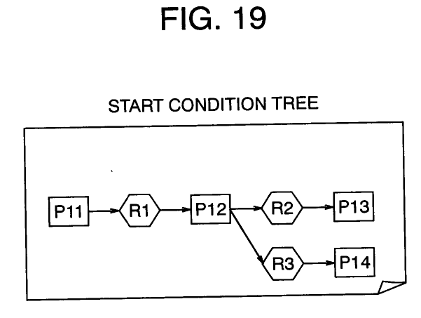

The plan/risk simulation processing of the plan/risk simulation processing portion 120 in the second embodiment executes the similar processing steps (S700 to S760 shown in FIG. 7) to the processing steps of the first embodiment with the exception that a part of the processing of S740 is different. Incidentally, because the project exemplified in the second embodiment is different from that of the first embodiment, the construction of the start condition tree generated in S710 is different. FIG. 19 typically shows the start condition tree generated by the plan/risk simulation processing portion 120 by using the action plan data 140 shown in FIG. 14 and the risk scenario data 150 shown in FIG. 15. The plan/risk simulation processing portion 120 in the second embodiment executes the processing of S715 to S760 by using the start tree shown in the drawing.

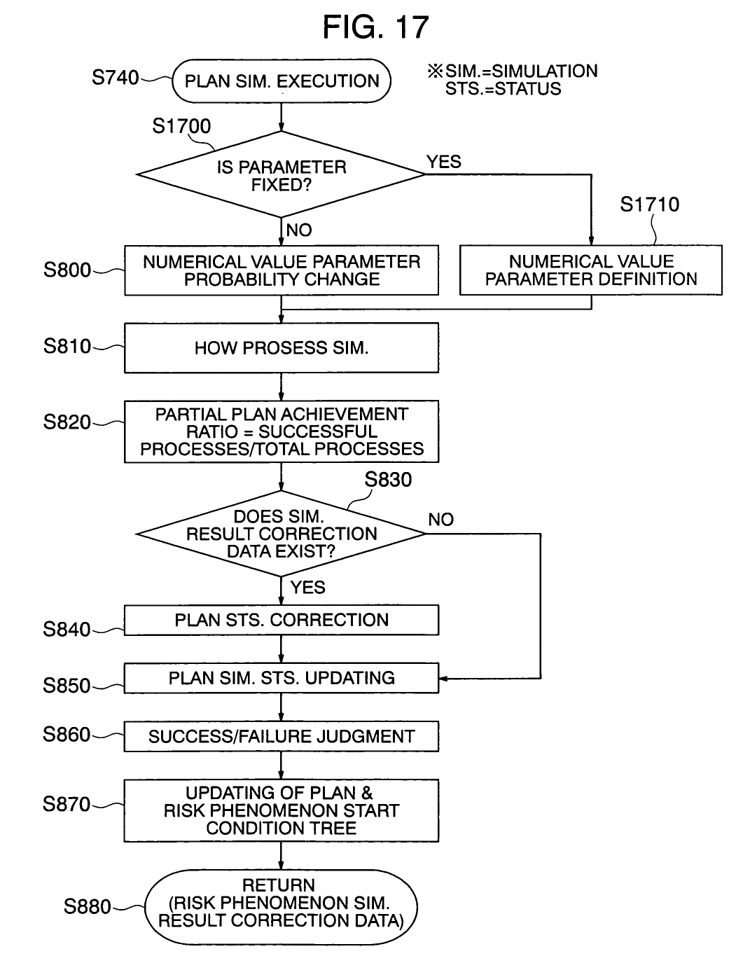

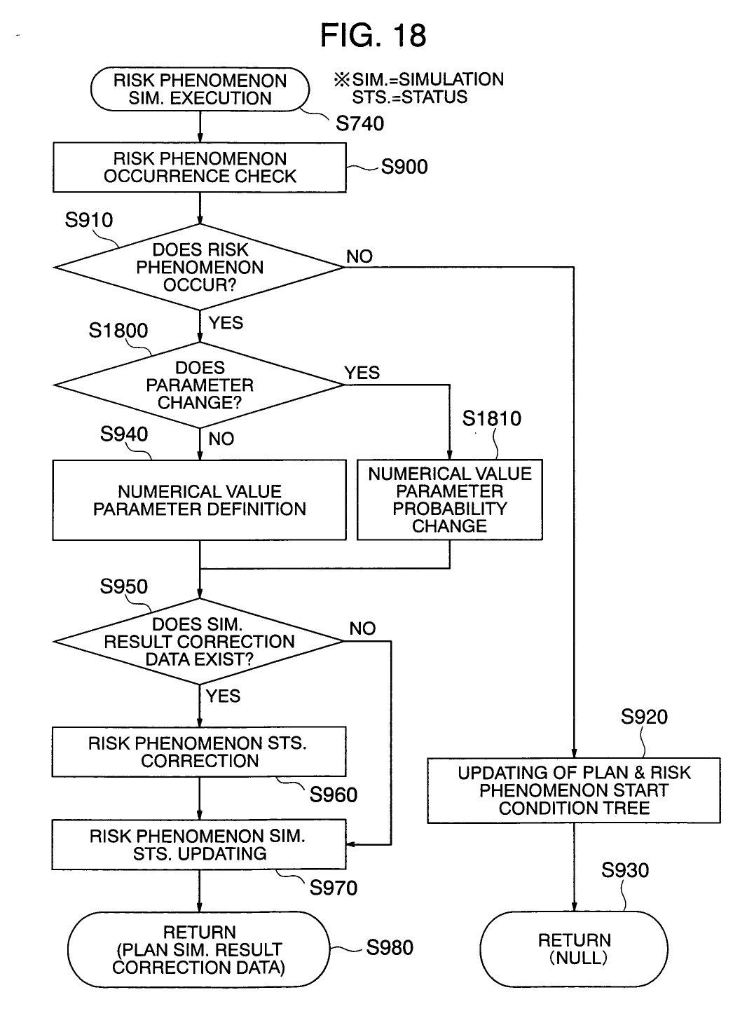

Subsequently, the processing of S740 executed by the plan/risk simulation processing portion 120 in the second embodiment will be explained with reference to FIGS. 17 and 18.

FIG. 17 is a flowchart useful for explaining the flow of the simulation processing for the action plan of the second embodiment. The simulation processing for the action plan in the second embodiment has the same processing steps as those of the first embodiment except that a part of the processing is different from the processing of the first embodiment shown in FIG. 8. More concretely, the difference from the first embodiment shown in FIG. 8 resides in that the simulation processing of the second embodiment is divided into the case where the probability change processing of the numerical parameter is made and the case where it is not, in accordance with the set action plan data 140 shown in FIG. 14 when simulation of each partial plan is executed.

The plan/risk simulation processing portion 120 checks (judges) whether or not the fix flag is set for the information designated by the numerical value diameter among the 4W1H information inside the partial plan data (S1700).

When the fix flag is found set as a result of the check, the plan/risk simulation processing portion 120 executes the same processing as that of the first embodiment shown in FIG. 8 (S800 to S880).

When the fix flag is not found set in S1700, on the other hand, the plan/risk simulation processing portion 120 employs as such the numerical value inside the partial plan data without creating the probability change of the numerical value (S1710). The plan/risk simulation processing portion 120 thereafter executes the processing of S810 to S880 shown in FIG. 8.

FIG. 18 is a flowchart useful for explaining the flow of the simulation processing for the risk scenario of the second embodiment. The simulation processing for the risk scenario is different from the processing of the first embodiment shown in FIG. 9 with exception that a part is different. More concretely, the difference from the first embodiment shown in FIG. 9 resides in that the simulation processing of the second embodiment executes the probability change processing of the numerical value parameter in accordance with setting of the risk scenario data 150 shown in FIG. 15 when simulation of each risk phenomenon is executed.

The plan/risk simulation portion 120 judges whether or not the risk phenomenon occurs on the basis of the occurrence probability inside the risk scenario data 150 in the same way as in the first embodiment shown in FIG. 9 (S900 to S910). When the risk phenomenon does not occur in S910, the plan/risk simulation processing portion 120 executes the same processing steps as those of S920 to S930 shown in FIG. 9. On the other hand, the plan/risk simulation processing portion 120 proceeds to S1800 when the risk phenomenon occurs in S910.

In S1800, the plan/risk simulation processing portion 120 checks (judges) whether or not the change flag is set for the information designated by the numerical value parameter among the 4W information inside the risk phenomenon data.

The plan/risk simulation processing portion 120 employs as such the numerical value as the definite value in the same way as the processing procedure of the first embodiment shown in FIG. 9 when the change flag is not set as a result of the check (S940) and then proceeds to S950.

The plan/risk simulation processing portion 120 changes probability-wise the numerical value (S1810) when the change flag is judged as set in S1800 and then proceeds to S950. Incidentally, any method may be used as the probability change method in the same way as the probability change method of the 4W1H numerical parameters inside the partial plan in the first embodiment.

The plan/risk simulation processing portion 120 thereafter executes the same processing as those of the embodiment shown in FIG. 9 (S950 to S980).

In addition to the effect brought forth by the first embodiment, the second embodiment can conduct simulation by arbitrarily fixing the numerical value parameters among the information on the action plan by the simulation processing of the action plan by using action plan input view 1600 executed by the plan/risk input processing portion 110 and the simulation processing (FIG. 17) for the action plan executed by the plan/risk simulation processing portion 120. The second embodiment can conduct simulation by arbitrarily changing probability-wise the numerical value parameters of the information among the risk phenomenon information by the input processing of the risk scenario executed by the plan/risk input processing portion 110 by using the risk scenario input view 1650 and the simulation execution processing (FIG. 18) for the risk phenomenon executed by the plan/risk simulation processing portion 120.

The second embodiment can explicitly define the risk generation party as the information about the risk phenomenon. Therefore, the range of application of the object of the project for simulation can be expanded to general projects such as a risk management (alert) project and a research and development project beside the natural disaster counter-measure project typically shown in the first embodiment. In other words, this embodiment can provide plan definition and evaluation method that do not depend on the kind of projects and works.

Incidentally, the invention is not limited to the embodiments described above but can be changed or modified in various ways within the scope thereof. For example, in view of a computer environment for executing the processing according to the invention, an arbitrary processing step in the embodiments may be finely divided into two or more processing steps or two or more arbitrary steps may be combined into one processing step. The form for accomplishing the invention is not particularly limited as long as the function provided by the invention is not deteriorated.

1. A simulation program for causing a computer to execute a processing for simulating execution of an action plan, wherein:
said computer includes a storage device, an input device and an output device;
said simulation program causes said computer to execute the steps of;
accepting input of action plan data for simulating execution of said action plan through said input device and storing said action plan data so accepted into said storage device;
accepting input of risk scenario data containing at least occurrence condition information of a risk phenomenon and influence information of said risk phenomenon on said action plan through said input device and storing said risk scenario data so accepted into said storage device;
reading out said action plan data and said risk scenario data from said storage device and executing simulation processing for execution of said action plan by using said action plan data and said risk scenario data so read out; and
calculating plan evaluation result information by applying predetermined statistic processing to said simulation result and outputting said plan evaluation result information to said output device; and
said simulation step comprises the steps of:
simulating an occurrence of said risk phenomenon by using said occurrence condition information of said risk phenomenon contained in said risk scenario data, determining influence information of said risk phenomenon on said action plan by using said influence information contained in said risk scenario data when said risk phenomenon is simulated as occurring, and simulating execution of said action plan by reflecting influences of said risk scenario on said action plan by using said action plan data and influence information of said risk phenomenon on said action plane so obtained.

2. A simulation program for causing a computer to execute a processing for simulating execution of an action plan, wherein:
said computer includes a storage device, an input device and an output device;
said simulation program causes said computer to execute the steps of:
accepting input of risk scenario data for simulating execution of an occurrence of a risk through said input device and storing said risk scenario data so accepted into said storage device;
accepting input of action plan data containing at least influence information of said action plan on said risk scenario through said input device and storing said action plan data so accepted into said storage device;
reading out said action plan data and said risk scenario data from said storage device and executing simulation processing for the occurrence of said risk by using said action plan data and said risk scenario data so read out; and
calculating plan evaluation result information by applying a predetermined statistic processing to said simulation result and outputting said plan evaluation result information to said output device; and
said simulation step comprises the steps of:
simulating execution of said action plan by using the execution condition information of said action plan contained in said action plan data, determining influence information of said action plan on said risk scenario by using said influence information contained in said action plan data simulated, and simulating the occurrence of said risk by reflecting influences of said action plan on said risk scenario by using said risk data and said influence information of said action plan on said risk scenario.

3. A simulation program for causing a computer to execute a processing for simulating the execution of an action plan, wherein:
said computer includes a storage device, an input device and an output device;
said simulation program causes said computer to execute the steps of:
accepting input of action plan data having at least action execution condition information and associated information of an action plan and a risk phenomenon through said input device and storing said action plan data so accepted into said storage device;
accepting input of risk scenario data containing at least risk phenomenon occurrence condition information and influence information of a risk phenomenon on said action plan through said input device and storing said risk scenario data so accepted into said storage device;
reading out said action plan data and said risk scenario data from said storage device and executing simulation processing for said action plan and said risk scenario by using said action plan data and said risk scenario data so read out; and
calculating a plan evaluation result from said simulation result and outputting said plan evaluation result to said output device; and
said simulation step comprises the steps of:
simulating the occurrence of said risk phenomenon, simulating the execution of said action plan while reflecting influence of said risk scenario on said action plan, simulating the execution of said action plan and simulating the occurrence of said risk phenomenon while reflecting influence of said action plan on said risk scenario.

4. A simulation program for causing a computer to execute a processing for simulating the execution of an action plan, wherein:
said computer includes a storage device and an output device;
said storage device stores action plan data constituted by partial plan information representing at least one partial plan and risk scenario data constituted by at least one risk phenomenon information affecting said action plan;
said partial plan information contains execution condition information of said partial plan and risk influence information representing influence given to said risk phenomenon by execution of said partial plan;
said risk phenomenon information contains occurrence condition information of said risk phenomenon and partial plan influence information representing influence given to said partial plan by occurrence of said risk phenomenon;
said simulation program causes said computer to execute the steps of:
reading out said action plan data and said risk scenario data from said storage device and specifying an object of simulation from among said partial plan information and said risk phenomenon information by using the execution condition information of said partial plan contained in said action plan data so read out and said occurrence condition information of said risk phenomenon contained in said risk scenario data so read out;
simulating execution of said partial plan by using said execution condition information contained in said partial plan information when said object specified is the partial plan information, determining influence information given to said risk phenomenon by execution of said partial plan by using risk influence information contained in said partial plan information, simulating occurrence of said risk phenomenon by using said occurrence condition information contained in said risk phenomenon information when said object specified is the risk phenomenon information, and determining influence information given to said partial plan by said risk phenomenon simulated by using said partial plan influence information contained in said risk phenomenon information; and
applying a predetermined statistic processing to the simulation result obtained by said simulation step to determine action plan evaluation data and outputting said action plan evaluation data to said output device;
said simulation step comprises the steps of:
judging whether or not said influence information on said specified partial plan exists in simulation result of said risk phenomenon information that has been already simulated when said object specified is said partial plan information, and correcting simulation result of said partial plan by using said influence information when said influence information exists; and
judging whether or not influence information on said risk phenomenon specified exists in the simulation result of said partial plan information that has been already simulated when said object specified is the risk phenomenon information, and correcting the simulation result of said risk phenomenon information by using said influence information when said influence information exists.

5. The simulation program according to claim 1, wherein:
said action plan data is constituted by at least one partial plan information;
said partial plan information contains all or any of plan name information, person-in-charge information representing a person in charge of said partial plan, period information representing an execution period of said partial plan, site information representing an execution site of said partial plan and execution outline information;
said influence information contained in said risk scenario data contains information for designating a partial plan affected by said risk phenomenon and information representing content of influences given to all or any of plan name information, person-in-charge information, period information, site information and execution outline information that are contained in said partial plan information designated;
said influence information given by said risk phenomenon determined to said action plan is information that designates the content of influences given to all or any of plan name information, person-in-charge information, period information, site information and execution outline information that are contained in said partial plan information designated; and
said simulation step simulates execution of said action plan by reflecting influences given to all or any of plan name information, person-in-charge information, period information, site information and execution outline information of said partial plan information designated by said influence information given by said risk phenomenon to said action plan.

6. The simulation program according to claim 2, wherein:
said risk scenario information is constituted by at least one risk phenomenon information;
said risk phenomenon information contains all or any of generation party information representing a party generating said risk phenomenon, occurrence period information representing an occurrence period of said risk phenomenon, occurrence site information representing an occurrence site of said risk phenomenon and influence information on said action plan;
said influence information contained in said risk action plan data contains information for designating said risk phenomenon affected by said action plan and information representing content of influences given to all or any of generation party information, occurrence period information, occurrence site information and influence information on said action plan that are contained in said risk phenomenon designated;
said influence information given by said action plan determined to said risk scenario is information that designates the content of influences given to all or any of generation party information, occurrence period information, occurrence site information and influence information on said action plan that are contained in said risk phenomenon information designated; and
said simulation step simulates the occurrence of said risk phenomenon by reflecting the influences given to all or any of generation party information, occurrence period information, occurrence site information and influence information on said action plan designated by the influence information given by said action plan determined on said risk scenario.

7. The simulation program according to claim 5, wherein:
said simulation step executes simulation of said partial plan by changing probability-wise a numerical value when all or any of plan name information, person-in-charge information, period information, site information and execution outline information that are contained in said partial plan information is designated by said numerical value.

8. The simulation program according to claim 6, wherein:
said simulation step executes simulation of said risk phenomenon by changing probability-wise a numerical value when all or any of generation party information information, generation period information, generation site information and influence information on said action plan information that are contained in said risk phenomenon information is designated by said numerical value.

9. The simulation program according to claim 4, wherein:
said partial plan information contains judgment information representing a condition of success or failure of said partial plan; and
said simulation step compares a simulation result of said partial plan with said judgment information, judges whether said partial plan is successful or failed and stops simulation of a subsequent action plan when said partial plan is judged as failure.
